(19) United States
(12) Patent Application Publication
(10) Pub. No.: US 2026/0247341 A1
(43) Pub. Date: Aug. 20, 2026

(54) MACHINE LEARNING MODELS FOR POSITIONING BASED ON RESPECTIVE COMBINATIONS OF ANCHOR DEVICES

(71) Applicant: QUALCOMM Incorporated, San Diego, CA (US)

(72) Inventors: Varun Amar REDDY, San Diego, CA (US); Jay Kumar SUNDARARAJAN, San Diego, CA (US); Alexandros MANOLAKOS, Athens (GR)

(21) Appl. No.: 19/161,259

(22) PCT Filed: Feb. 2, 2024
(86) PCT No.: PCT/US2024/014137

§ 371 Date: Aug. 31, 2025

(30) Foreign Application Priority Data
Mar. 22, 2023 (GR) 20230100235

(51) Int. Cl. H04W 64/00

(52) U.S. Cl. CPC H04W 64/006

(57) ABSTRACT

Disclosed are techniques for wireless communication. In an aspect, a user device may transmit observable anchor information to a network entity, the observable anchor information indicating a set of anchor devices observable by the user device. The user device may obtain assistance information from the network entity, the assistance information indicating a machine learning model corresponding to the set of anchor devices. The user device may engage in a positioning procedure that is based on the machine learning model with at least a subset of the set of anchor devices for determining an estimated location of the user device.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user device includes transmitting observable anchor information to a network entity, the observable anchor information indicating a set of anchor devices observable by the user device; obtaining assistance information from the network entity, the assistance information indicating a machine learning model corresponding to the set of anchor devices; and engaging in a positioning procedure that is based on the machine learning model with at least a subset of the set of anchor devices for determining an estimated location of the user device.

In an aspect, a method of wireless communication performed by a network entity includes receiving observable anchor information from a user device, the observable anchor information indicating a set of anchor devices observable by the user device; and transmitting assistance information to the user device based on a machine learning model corresponding to the set of anchor devices being available, wherein the machine learning model is usable for determining an estimated location of the user device.

In an aspect, a method of wireless communication performed by a user device includes obtaining assistance information from a network entity, the assistance information indicating one or more candidate machine learning models corresponding to respective one or more candidate sets of anchor devices; selecting a machine learning model from the one or more candidate machine learning models based on a set of anchor devices that are observable by the user device; and engaging in a positioning procedure that is based on the selected machine learning model with at least a subset of the corresponding set of anchor devices of the one or more candidate sets of anchor devices for determining an estimated location of the user device.

In an aspect, a method of wireless communication performed by a network entity includes obtaining device information of a user device; and transmitting assistance information to the user device based on the device information, the assistance information indicating one or more candidate machine learning models corresponding to respective one or more candidate sets of anchor devices, wherein at least a machine learning model of the one or more candidate machine learning models is selectable for determination of an estimated location of the user device.

In an aspect, a user device includes a memory; at least one transceiver; and at least one processor communicatively coupled to the memory and the at least one transceiver, the at least one processor configured to: transmit, via the at least one transceiver, observable anchor information to a network entity, the observable anchor information indicating a set of anchor devices observable by the user device; obtain assistance information from the network entity, the assistance information indicating a machine learning model corresponding to the set of anchor devices; and engage in a positioning procedure that is based on the machine learning model with at least a subset of the set of anchor devices for determining an estimated location of the user device.

In an aspect, a network entity includes a memory; at least one transceiver; and at least one processor communicatively coupled to the memory and the at least one transceiver, the at least one processor configured to: receive, via the at least one transceiver, observable anchor information from a user device, the observable anchor information indicating a set of anchor devices observable by the user device; and transmit, via the at least one transceiver, assistance information to the user device based on a machine learning model corresponding to the set of anchor devices being available, wherein the machine learning model is usable for determining an estimated location of the user device.

In an aspect, a user device includes a memory; at least one transceiver; and at least one processor communicatively coupled to the memory and the at least one transceiver, the at least one processor configured to: obtain assistance information from a network entity, the assistance information indicating one or more candidate machine learning models corresponding to respective one or more candidate sets of anchor devices; select a machine learning model from the one or more candidate machine learning models based on a set of anchor devices that are observable by the user device; and engage in a positioning procedure that is based on the selected machine learning model with at least a subset of the corresponding set of anchor devices of the one or more candidate sets of anchor devices for determining an estimated location of the user device.

In an aspect, a network entity includes a memory; at least one transceiver; and at least one processor communicatively coupled to the memory and the at least one transceiver, the at least one processor configured to: obtain device information of a user device; and transmit, via the at least one transceiver, assistance information to the user device based on the device information, the assistance information indicating one or more candidate machine learning models corresponding to respective one or more candidate sets of anchor devices, wherein at least a machine learning model of the one or more candidate machine learning models is selectable for determination of an estimated location of the user device.

In an aspect, a user device includes means for transmitting observable anchor information to a network entity, the observable anchor information indicating a set of anchor devices observable by the user device; means for obtaining assistance information from the network entity, the assistance information indicating a machine learning model corresponding to the set of anchor devices; and means for engaging in a positioning procedure that is based on the machine learning model with at least a subset of the set of anchor devices for determining an estimated location of the user device.

In an aspect, a network entity includes means for receiving observable anchor information from a user device, the observable anchor information indicating a set of anchor devices observable by the user device; and means for transmitting assistance information to the user device based on a machine learning model corresponding to the set of anchor devices being available, wherein the machine learning model is usable for determining an estimated location of the user device,

In an aspect, a user device includes means for obtaining assistance information from a network entity, the assistance information indicating one or more candidate machine learning models corresponding to respective one or more candidate sets of anchor devices; means for selecting a machine learning model from the one or more candidate machine learning models based on a set of anchor devices that are observable by the user device; and means for engaging in a positioning procedure that is based on the selected machine learning model with at least a subset of the corresponding set of anchor devices of the one or more candidate sets of anchor devices for determining an estimated location of the user device.

In an aspect, a network entity includes means for obtaining device information of a user device; and means for transmitting assistance information to the user device based on the device information, the assistance information indicating one or more candidate machine learning models corresponding to respective one or more candidate sets of anchor devices. wherein at least a machine learning model of the one or more candidate machine learning models is selectable for determination of an estimated location of the user device.

In an aspect, a non-transitory computer-readable medium stores computer-executable instructions that, when executed by a user device, cause the user device to: transmit observable anchor information to a network entity, the observable anchor information indicating a set of anchor devices observable by the user device; obtain assistance information from the network entity, the assistance information indicating a machine learning model corresponding to the set of anchor devices; and engage in a positioning procedure that is based on the machine learning model with at least a subset of the set of anchor devices for determining an estimated location of the user device.

In an aspect, a non-transitory computer-readable medium stores computer-executable instructions that, when executed by a network entity, cause the network entity to: receive observable anchor information from a user device, the observable anchor information indicating a set of anchor devices observable by the user device; and transmit assistance information to the user device based on a machine learning model corresponding to the set of anchor devices being available, wherein the machine learning model is usable for determining an estimated location of the user device.

In an aspect, a non-transitory computer-readable medium stores computer-executable instructions that, when executed by a user device, cause the user device to: obtain assistance information from a network entity, the assistance information indicating one or more candidate machine learning models corresponding to respective one or more candidate sets of anchor devices; select a machine learning model from the one or more candidate machine learning models based on a set of anchor devices that are observable by the user device; and engage in a positioning procedure that is based on the selected machine learning model with at least a subset of the corresponding set of anchor devices of the one or more candidate sets of anchor devices for determining an estimated location of the user device.

In an aspect, a non-transitory computer-readable medium stores computer-executable instructions that, when executed by a network entity, cause the network entity to: obtain device information of a user device; and transmit assistance information to the user device based on the device information, the assistance information indicating one or more candidate machine learning models corresponding to respective one or more candidate sets of anchor devices, wherein at least a machine learning model of the one or more candidate machine learning models is selectable for determination of an estimated location of the user device.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 is a graph representing a radio frequency (RF) channel impulse response over time, according to aspects of the disclosure.

FIG. 6 illustrates an example neural network, according to aspects of the disclosure.

FIG. 7 is a diagram illustrating the use of a machine learning model for RF fingerprinting (RFFP)-based positioning, according to aspects of the disclosure.

FIG. 8 is a diagram illustrating the inference cycle for UE-based downlink RFFP (DL-RFFP) positioning, according to aspects of the disclosure,

FIG. 9 illustrates an example process flow for UE-based downlink-based RFFP positioning, according to aspects of the disclosure.

FIG. 10 is a diagram illustrating the use of machine learning models for determining estimated times of arrival (ToAs) for positioning, according to aspects of the disclosure.

FIG. 11A is a diagram illustrating an example setting for determining an estimated location of a target device and a channel response measured by the target device, according to aspects of the disclosure.

FIG. 11B is a diagram illustrating converting the channel response in FIG. 11A to a probability distribution of ToAs, according to aspects of the disclosure.

FIG. 11C is a diagram illustrating determining an estimated location of the target device in FIG. 11A based on the probability distribution of ToAs in FIG. 11B, according to aspects of the disclosure.

FIG. 12 is a diagram illustrating an indoor environment that includes a transmission-reception point (TRP) and a plurality of access points (APs), according to aspects of the disclosure.

FIG. 13 illustrates an example process flow for enabling the use of a machine learning (ML) model that corresponds to a set of TRPs observable by a UE, according to aspects of the disclosure.

FIG. 14 illustrates an example process flow for enabling the use of an ML model that corresponds to a set of anchor devices observable by a user device, according to aspects of the disclosure.

FIG. 15 illustrates an example process flow for enabling the use of an ML model from one or more candidate ML models corresponding to one or more candidate sets of TRPs, according to aspects of the disclosure.

FIG. 16 illustrates an example process flow for enabling the use of an ML model from one or more candidate ML models corresponding to one or more candidate sets of anchor devices, according to aspects of the disclosure.

FIG. 17 illustrates an example method of operating a user device, according to aspects of the disclosure.

FIG. 18 illustrates an example method of operating a network entity, according to aspects of the disclosure.

FIG. 19 illustrates an example method of operating a user device, according to aspects of the disclosure.

FIG. 20 illustrates an example method of operating a network entity, according to aspects of the disclosure.

### DETAILED DESCRIPTION

Aspects of the disclosure are provided in the following description and related drawings directed to various examples provided for illustration purposes. Altemate aspects may be devised without departing from the scope of the disclosure. Additionally, well-known elements of the disclosure will not be described in detail or will be omitted so as not to obscure the relevant details of the disclosure.

Various aspects relate generally to machine learning model based positioning procedures. Some aspects more specifically relate to using a machine learning model that corresponds to a particular set of anchor devices. In some examples, a user device or a network entity may select or identify a machine learning model that is suitable for a positioning procedure performed based on a set of anchor devices observable by the user device.

Particular aspects of the subject matter described in this disclosure can be implemented to realize one or more of the following potential advantages. In some examples, by identifying or selecting a machine learning model specific for a set of anchor devices observable by a user device, the described techniques can be used to perform a machine learning model based positioning procedure with improved performance from balancing the factors of precision of the estimated location and the computational complexity of the applied machine learning model.

The words “exemplary” and/or “example” are used herein to mean “serving as an example, instance, or illustration,” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR) / virtual reality (VR) headset, etc.), vehicle (e.g., automobile, motorcycle, bicycle, etc.), Internet of Things (IOT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station, Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs), An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

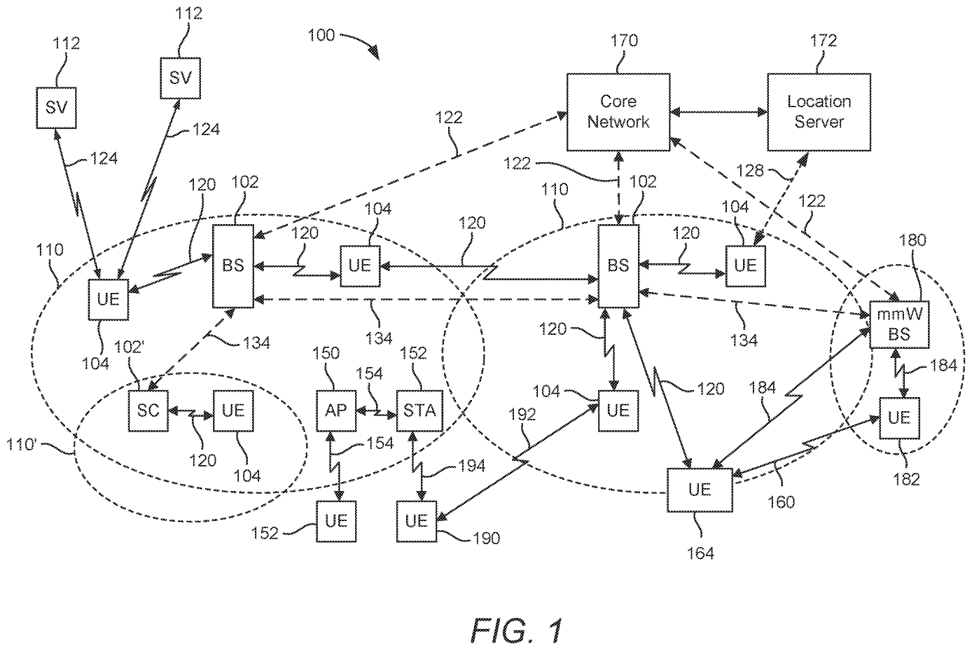

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be extemal to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IOT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage arca of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mm W) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mm W/near mm W radio frequency band have high path loss and a relatively short range. The mmW base station 180 and the UE 182 may utilize beamforming (transmit and/or receive) over a mm W communication link 184 to compensate for the extremely high path loss and short range. Further, it will be appreciated that in alternative configurations, one or more base stations 102 may also transmit using mmW or near mm W and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam, Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1 , or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier.” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mm W base station 180 may support one or more SCells for the UE 164.

In some cases, the UE 164 and the UE 182 may be capable of sidelink communication, Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. I only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®), and so on.

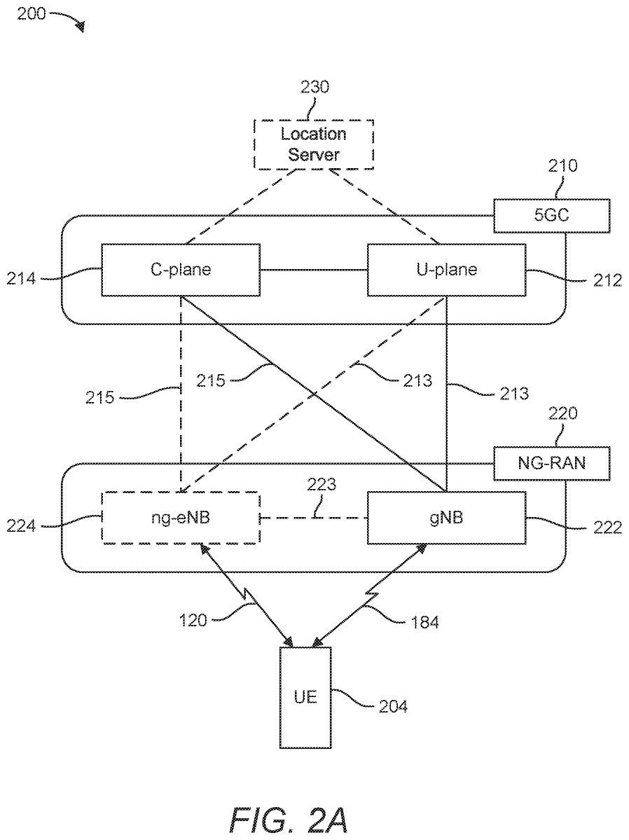

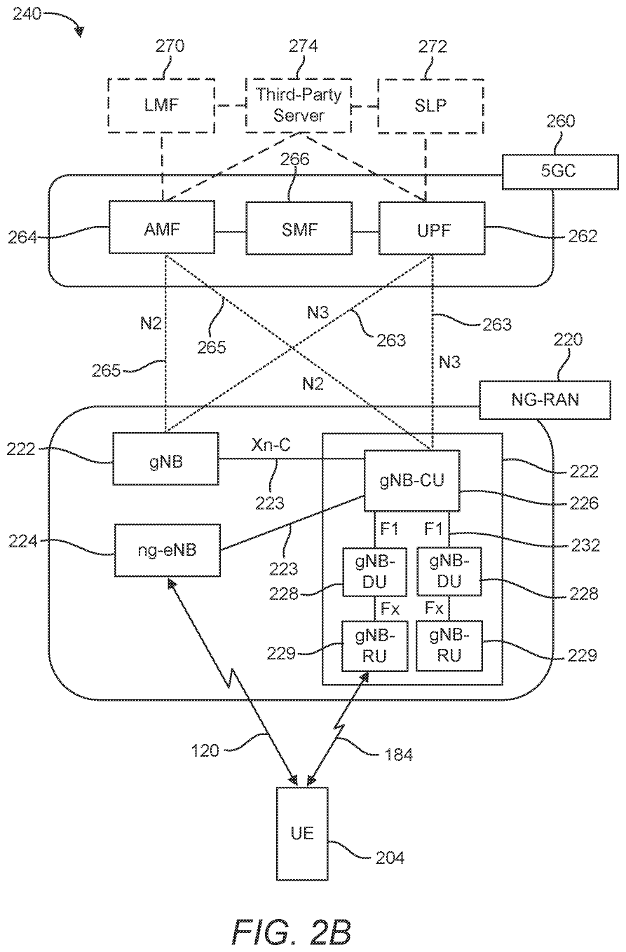

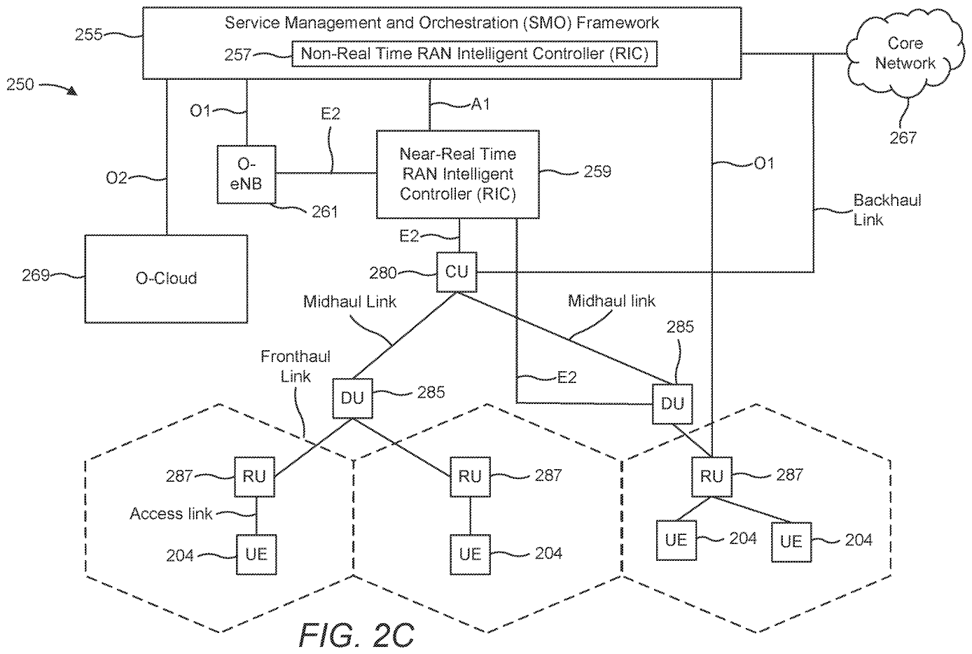

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or altemately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit—User Plane (CU-UP)), control plane functionality (i.e., Central Unit—Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261. via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an Al interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

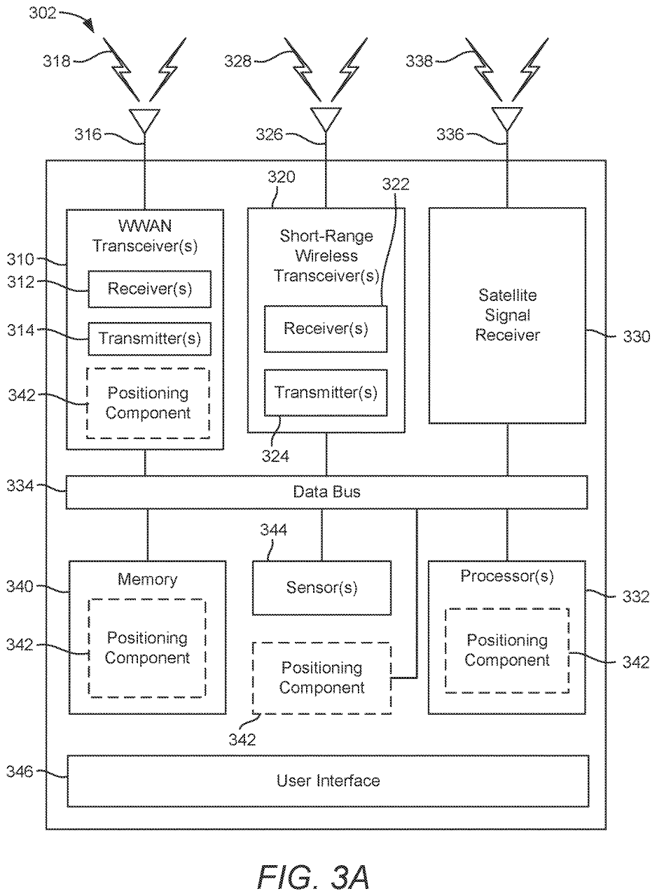

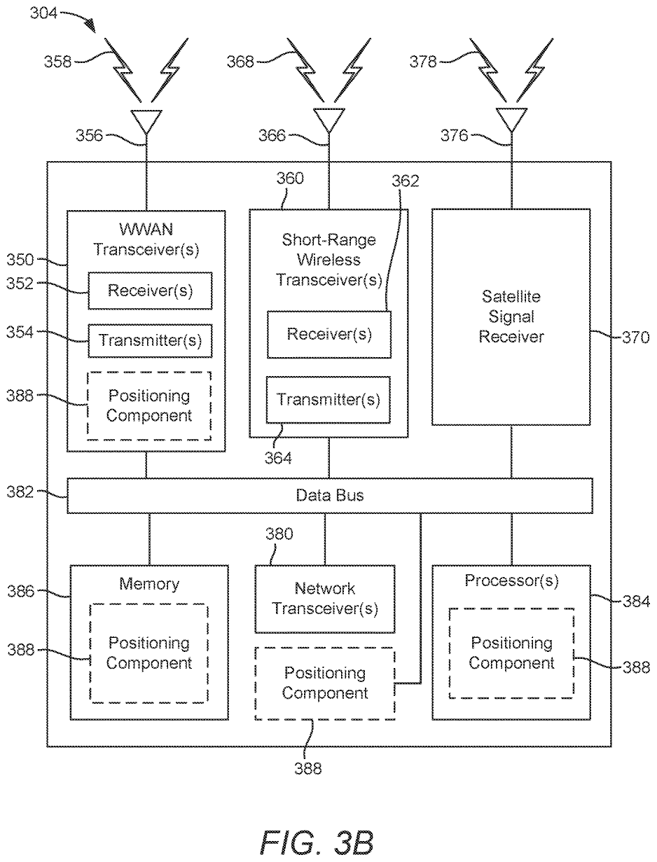

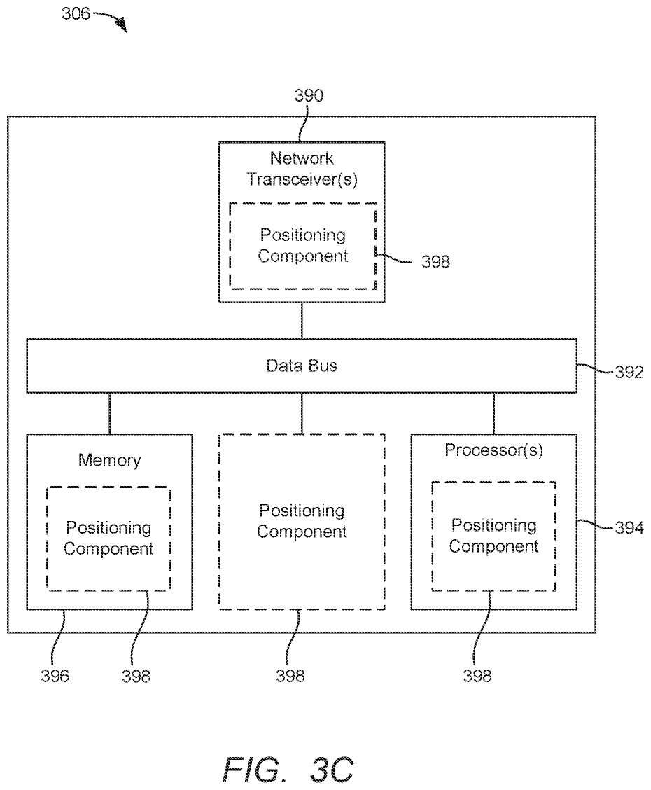

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave®) transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream, The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE.” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

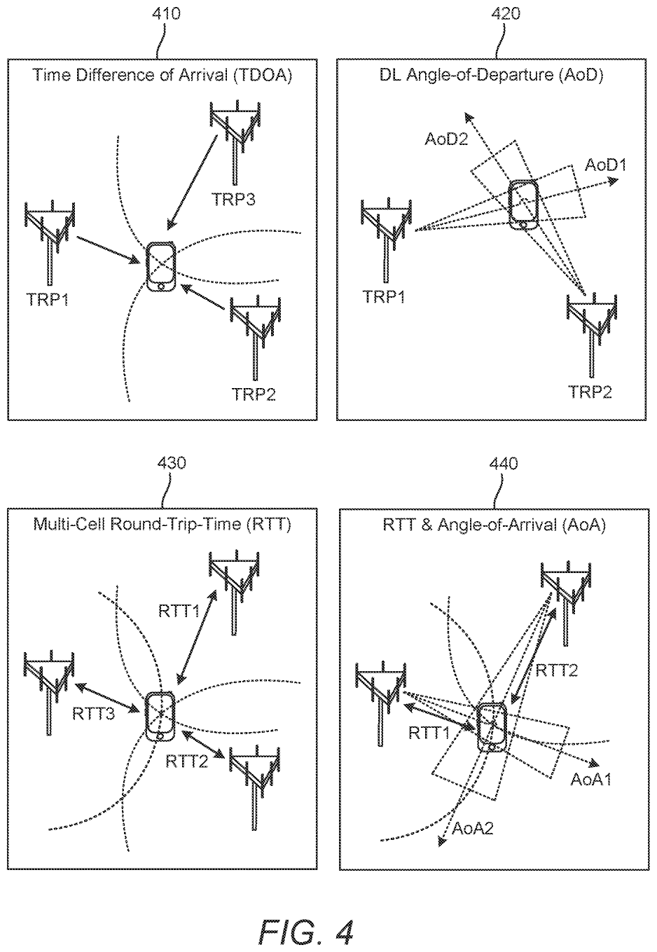

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements, In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1 , the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

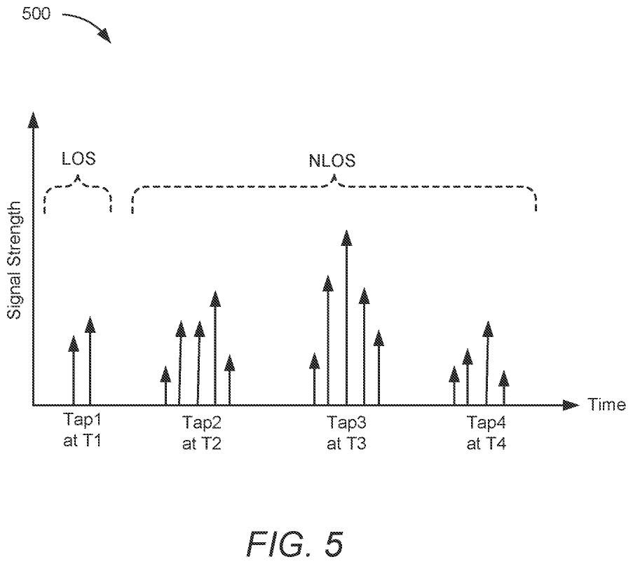

FIG. 5 is a graph 500 representing an example channel estimate of a multipath channel between a receiver device (e.g., any of the UEs or base stations described herein) and a transmitter device (e.g., any other of the UEs or base stations described herein), according to aspects of the disclosure. The channel estimate represents the intensity of a radio frequency (RF) signal (e.g., a positioning reference signal (PRS)) received through a multipath channel as a function of time delay, and may be referred to as the channel energy response (CER), channel impulse response (CIR), or power delay profile (PDP) of the channel. Thus, the horizontal axis represents time (e.g., milliseconds) and the vertical axis represents signal strength (e.g., decibels). Note that a multipath channel is a channel between a transmitter and a receiver over which an RF signal follows multiple paths, or multipaths, due to transmission of the RF signal on multiple beams and/or to the propagation characteristics of the RF signal (e.g., reflection, refraction, etc.).

In the example of FIG. 5, the receiver detects/measures multiple (four) channel taps of the RF signal. Each channel tap is a cluster of one or more rays and corresponds to a multipath that the RF signal followed between the transmitter and the receiver. Thus, a channel tap represents the time of arrival and signal strength of an RF signal over a multipath. There may be multiple channel taps due to the RF signal being transmitted on different transmit beams (and therefore at different angles), or because of the propagation characteristics of RF signals (e.g., potentially following different paths due to reflections), or both. Note that although FIG. 5 illustrates channel taps of two to five rays, as will be appreciated, the channel taps may have more or fewer than the illustrated number of rays.

In the example of FIG. 5, the channel tap detected at time T3 is composed of stronger rays than the channel tap detected at time T1. This may be due to an obstruction on the LOS path between the transmitter and the receiver. Alternatively or additionally, there may be a strong reflector along the NLOS path corresponding to the channel tap detected at time T3.

Machine learning may be used to generate models that may be used to facilitate various aspects associated with processing of data. One specific application of machine learning relates to generation of measurement models for processing of reference signals for positioning (e.g., positioning reference signal (PRS)), such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

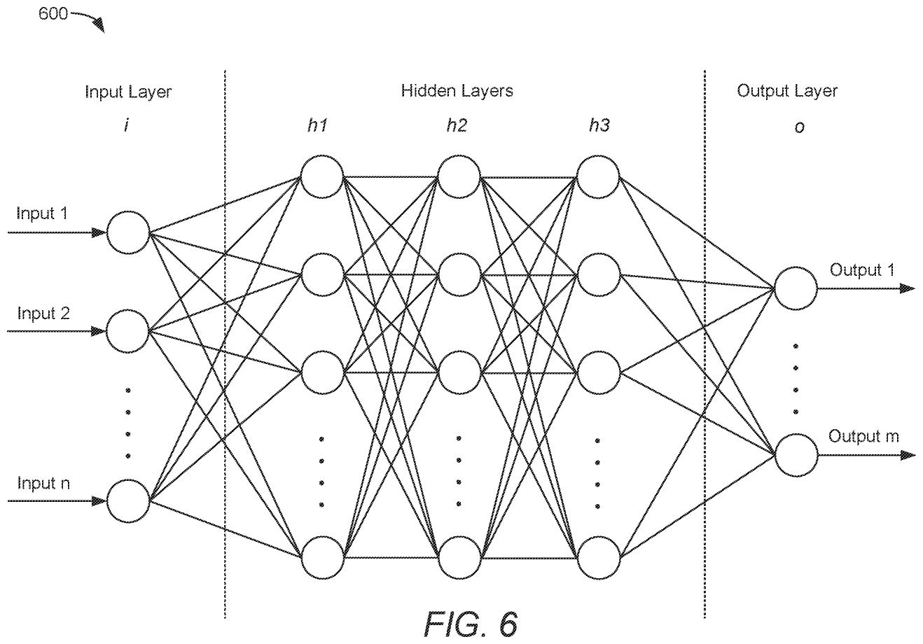

FIG. 6 illustrates an example neural network 600, according to aspects of the disclosure. The neural network 600 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction, One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system, such as processors 332, 384, or 394) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

NR supports RF fingerprint (RFFP)-based positioning, a type of positioning and localization technique that utilizes RFFPs captured by mobile devices to determine the locations of the mobile devices. An RFFP may be a histogram of a received signal strength indicator (RSSI), a CER, a CIR, a PDP, or a channel frequency response (CFR). An RFFP may represent a single channel received from a transmitter (e.g., a PRS), all channels received from a particular transmitter, or all channels detectable at the receiver, The RFFP(s) measured by a mobile device (e.g., a UE) and the locations of the transmitter(s) associated with the measured RFFP(s) (i.e., the transmitters transmitting the RF signals measured by the mobile device to determine the RFFP(s)) can be used to determine (e.g., triangulate) the location of the mobile device.

Machine learning positioning techniques have been shown to provide superior positioning performance when compared to classical positioning schemes. In machine learning-RFFP-based positioning, a machine learning model (e.g., neural network 600) takes as input the RFFPs of downlink reference signals (e.g., PRS) and outputs the positioning measurement (e.g., ToA, RSTD) or mobile device location corresponding to the inputted RFFPs. The machine learning model (e.g., neural network 700) is trained using the “ground truth” (i.e., known) positioning measurements or mobile device locations as the reference (i.e., expected) output of a training set of RFFPs.

For example, a machine learning model may be trained to determine the RSTD measurement of a pair of TRPs from RFFPs of PRS transmitted by the TRPs. The reference output for training such a model would be the correct (i.e., ground truth) RSTD measurement for the location of the mobile device at the time the mobile device obtained the RFFP measurements of the PRS. The network (e.g., location server) can determine the RSTD that would be expected for the pair of TRPs based on the known location of the mobile device and the known locations of the involved (measured) TRPs. The known location of the mobile device may be determined from multiple reported RSTD measurements and/or any other measurements reported by the mobile device (e.g., GPS measurements).

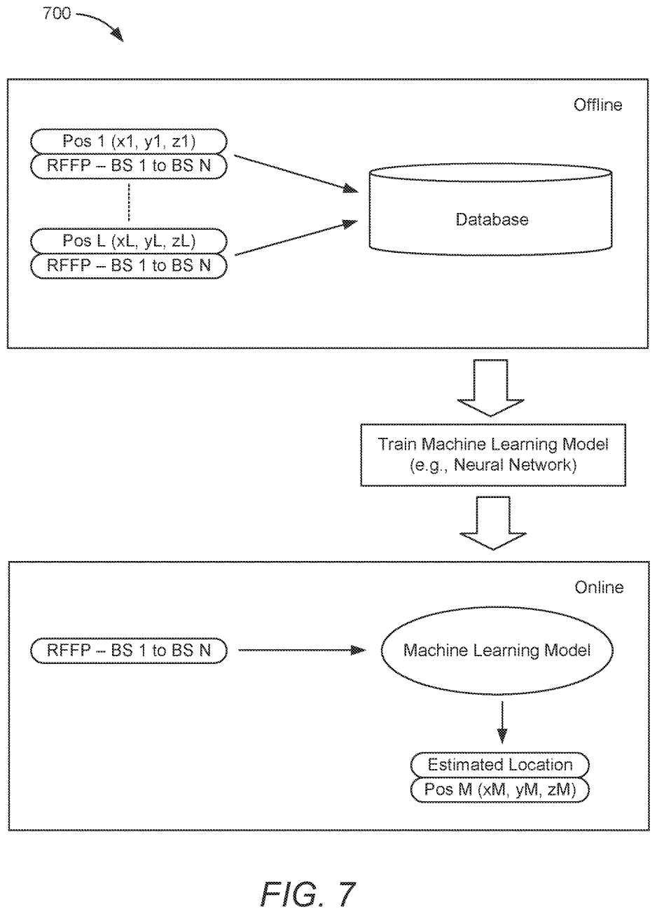

FIG. 7 is a diagram 700 illustrating the use of a machine learning model for RFFP-based positioning, according to aspects of the disclosure. In the example of FIG. 7, during an “offline” stage, RFFPs (e.g., CERs/CIRs/CFRs) captured by a mobile device are stored in a database. The database may be located at the mobile device or a network entity (e.g., a location server), and each RFFP may include measurements of RF signals (or channels or links) transmitted by one or more transmitters, illustrated in FIG. 7 as base stations 1 to N (i.e., “BS 1” to “BS N”). For UE-based downlink RFFP (DL-RFFP) positioning, the network (e.g., the location server) configures the base stations to transmit downlink reference signals (e.g., PRS) to the mobile device, and the RFFPs are the CER(s)/CIR(s)/CFR(s) of the configured downlink reference signals detected by the mobile device.

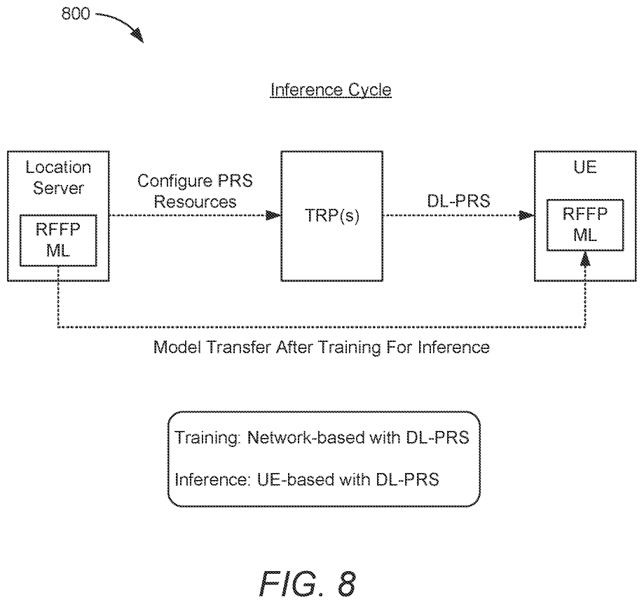

Each measured RFFP is associated with the known location of the mobile device at the time the mobile device measured the RFFP, illustrated in FIG. 8 as positions I to L (i.e., “Pos 1” to “Pos L”). The mobile device's location may be known via another positioning technique, such as discussed above with reference to FIG. 4. Note that although FIG. 7 illustrates RFFP information for a single mobile device, as will be appreciated, RFFP information for multiple mobile devices can be collected and stored in the database.

Based on the information captured during the offline stage, a machine learning model (e.g., neural network 600) is trained to estimate the location of a mobile device based on RFFPs measured by the mobile devices. More specifically, a training set of RFFP measurements is used as input to the machine learning model and the known locations of the mobile devices when capturing the RFFPs are used as labels. After training, during an “online” stage, the trained machine learning model can be used to estimate (infer) the location of a mobile device (illustrated as “Pos M”) based on the RFFP(s) currently measured by the mobile device. For UE-based RFFP positioning, the network (e.g., the location server) provides the trained machine learning model to the mobile device. For UE-assisted positioning, the mobile device may provide the RFFP measurements to the network for processing.

Note that although FIG. 7 illustrates using an RFFP-based machine learning model to estimate the location of a UE, the outputs (or extracted features) of the machine learning model may instead be positioning measurements based on the input RFFPs, such as RSTD measurements, ToA measurements, DL-AoD measurements, etc.

FIG. 8 is a diagram 800 illustrating the inference cycle for UE-based DL-RFFP positioning, according to aspects of the disclosure. As shown in FIG. 8, the location server (e.g., LMF 270) configures DL-PRS resources to be transmitted by one or more TRPs during a positioning session with a UE. The TRP(s) then transmit the configured DL-PRS to the UE, which measures the RFFPs of the DL-PRS.

In the example of FIG. 8, the location server previously trained a machine learning model for RFFP positioning (labeled “RFFP ML”), as discussed above with reference to FIGS. 6 and 7. The location server provides the machine learning model to the UE to perform inferences (e.g., determining a positioning measurement based on the measured RFFPs) during the positioning session. As such, after measuring the RFFPs of the DL-PRS, the UE inputs the measured RFFPs to the received machine learning model to obtain the associated positioning measurement(s) (e.g., ToA, RSTD).

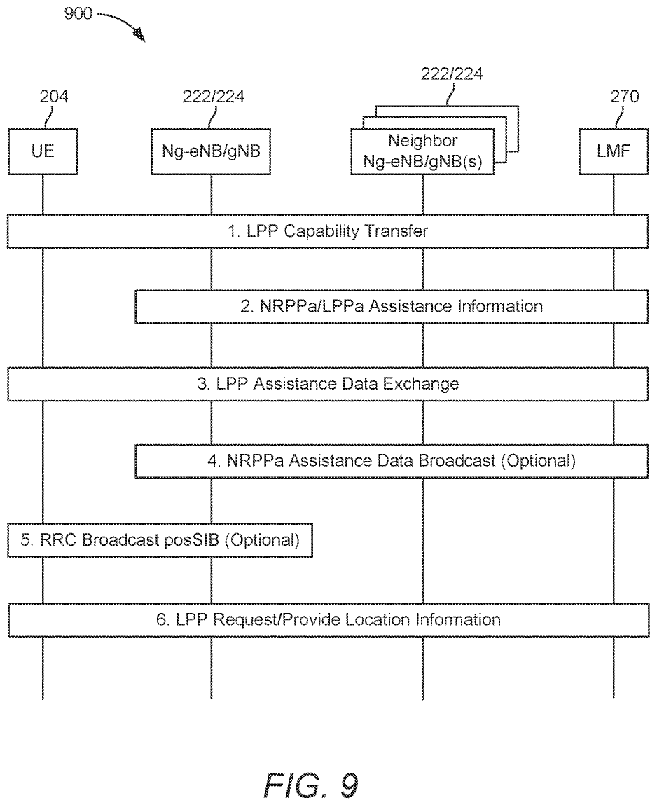

FIG. 9 illustrates an example process flow 900 for UE-based downlink-based RFFP positioning, according to aspects of the disclosure. At stage 1, the UE 204 and LMF 270 perform an LPP positioning capability transfer procedure during which the UE 204 provides its positioning capabilities to the LMF 270. At stage 2, the LMF 270 provides assistance information to the UE's 204 serving ng-eNB/gNB 222/224 and any neighboring ng-eNBs/gNBs 222/224, such as the PRS resource configuration of the DL-PRS to be transmitted to the UE 204. At stage 3, the UE 204 and LMF 270 perform an LPP assistance data exchange. During the exchange, the LMF 270 provides assistance data to the UE 204 for the positioning session, such as the configuration of the DL-PRS transmitted by the involved ng-eNBs/gNBs 222/224 and the machine learning model to use to report positioning measurements of the DL-PRS.

At stage 4, the LMF 270 optionally provides assistance information to the involved ng-eNBs/gNBs 222/224 via New Radio positioning protocol type A (NRPPa) messages. At stage 5, the serving ng-eNB/gNB 222/224 optionally broadcasts the assistance information received from the LMF 270 as assistance data in one or more positioning SIBs (posSIBs). At stage 6, the LMF 270 and the UE 204 perform an LPP request/provide location information procedure, during which the UE 204 provides positioning measurements taken of the DL-PRS transmitted by the ng-eNBs/gNBs 222/224. The positioning measurements may be derived by applying the machine learning model received in the assistance data to the RFFPs of the measured DL-PRS.

Machine learning tools, their impact on the air interface, and their lifecycle management are currently being studied, using some representative use cases as guidelines. One of these use cases, as noted above, is positioning. The identified areas for investigation include characterizing the lifecycle management of the AI/ML model, such as model training, model deployment, model inference, model monitoring, and model updating. The areas of investigation further include the dataset(s) for training, validation, testing, and inference.

While the machine learning (ML) techniques may be used in an RFFP positioning procedure as described with reference to FIGS. 7-9, the ML techniques may also be used in other parts of the positioning procedure. In some examples, the ML techniques may be used to determine or refine intermediate measurements (e.g., ToA, RTT, AoA, TDoA, AoD, or any combination thereof) for a positioning procedure.

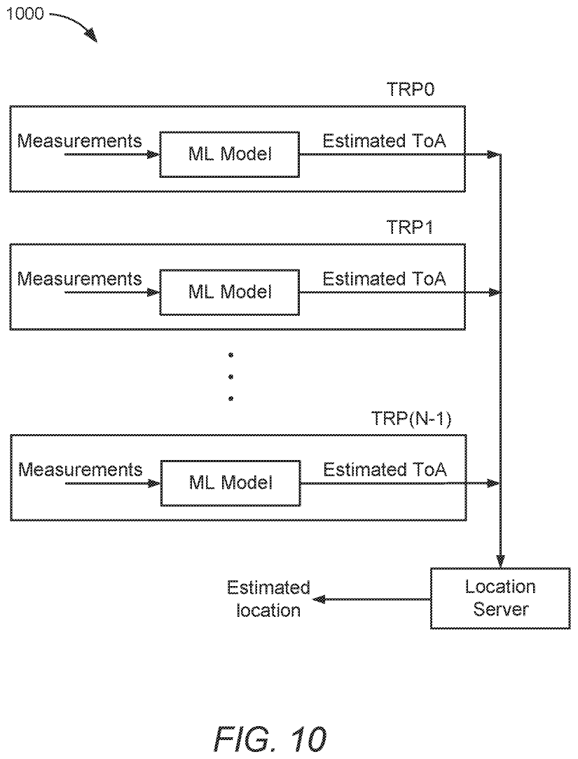

FIG. 10 is a diagram 1000 illustrating the use of machine learning models for determining estimated ToAs for positioning, according to aspects of the disclosure. In this non-limiting example, a target device (e.g., a UE) may engage in a positioning procedure with N TRPs (labeled as TRP0, TRP1, . . . , TRP(N-1)). In this example, each of the N TRPs may obtain measurements (e.g., a time domain CIR) of signals from the target device and may each determine a respective estimated ToA by applying a respective ML model to the measurements. The N TRPs may transmit the respectively determined ToAs to a location server (e.g., an LMF). The location server may obtain an estimated location of the target device based on the estimated ToAs from the ML models.

Also, in some examples, the ML techniques may be used to map the intermediate measurements (e.g., ToA, RTT, AoA, TDoA, AoD, or any combination thereof) to a probability distribution that represents a probabilistic view of where the target device may be located (e.g., in two-dimensional or in three-dimensional space).

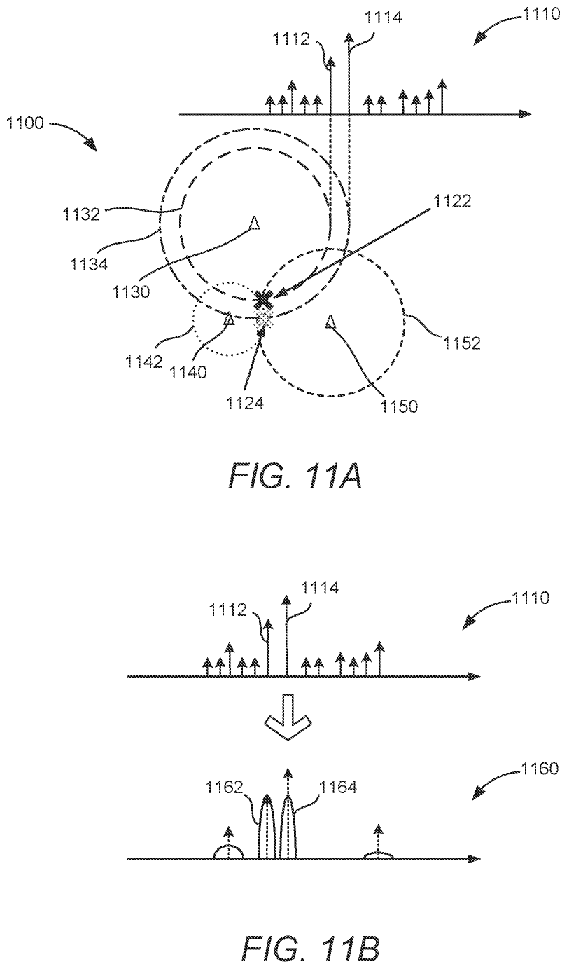

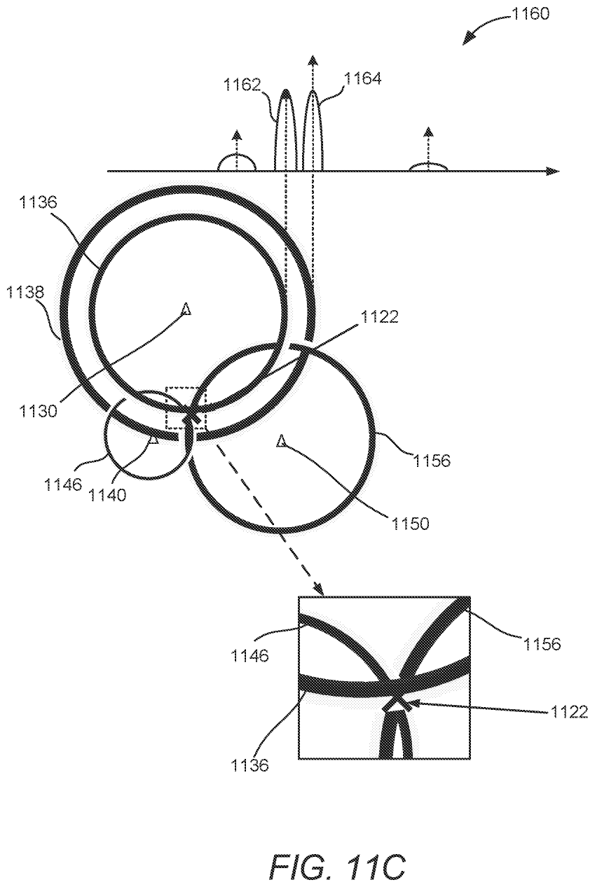

FIG. 11A is a diagram illustrating an example setting 1100 for determining an estimated location of a target device and a channel response 1110 measured by the target device, according to aspects of the disclosure. In the example setting 1100, a target device is located at a true location 1122. The example setting 1100 further includes three anchor devices: a first TRP 1130, a second TRP 1140, and a third TRP 1150. The channel response 1110 represents the channel response of the signals from the first TRP 1130 measured by the target device. In the channel response 1110, the tap 1112 represents a signal along a line-of-sight (LOS) path from the first TRP 1130 to the target device, and the tap 1114 represents a signal along a non-line-of-sight (NLOS) path from the first TRP 1130 to the target device. In some scenarios, the channel conditions of the LOS path and the NLOS path may result in the NLOS tap 1114 having a stronger signal strength than the LOS tap 1112.

Based on the channel response 1110, the estimated ToAs of the LOS tap 1112 and the NLOS tap 1114 may be depicted as estimated ranges 1132 and 1134, respectively. Moreover, based on the channel responses of the signals from the second TRP 1140 and the third TRP 1150, the respective ToAs may be depicted as estimated ranges 1142 and 1152, respectively. In some aspects, a positioning procedure may be unaware of the LOS or NLOS conditions of the received signals and may use the estimated range 1134 (e.g., ToA thereof being overestimated) for determining an estimated location of the target device. Accordingly, in this example, the resulting estimated location of the target device based on the estimated range 1134 may be at the estimated location 1124, with a significant error from the true location 1122.

FIG. 11B is a diagram illustrating converting the channel response 1110 in FIG. 11A to a probability distribution of ToAs 1160, according to aspects of the disclosure. To address the issue of having an overestimated ToA as illustrated with reference to FIG. 11A, the channel response 1110 in FIG. 11A may be converted to a probability distribution of ToAs 1160, which may be determined based on the ML techniques. However, in some other examples, the conversion may be performed based on a probability mapping without using the ML techniques.

In this example, the LOS tap 1112 and the NLOS tap 1114 may be converted to a LOS ToA probability distribution 1162 and an NLOS ToA probability distribution 1164. In some aspects when the conversion is performed based on the ML techniques, as the ML model used for the conversion may have been trained based on training data and ground truth data, the probability distribution of ToAs 1160 may better reflect the likelihood of the locations of the target device and thus may reduce the impact of the NLOS signal.

FIG. 11C is a diagram illustrating determining an estimated location of the target device in FIG, 11A based on the probability distribution of ToAs in FIG. 11B, according to aspects of the disclosure. The components that are the same or similar to the components in FIG. 11A are given the same reference numbers, and the detail description thereof may be omitted. The method as illustrated in FIG. 11C may also be referred to as likelihood fusion (“ML model-based likelihood fusion” with the probability distribution of ToAs obtained based on the ML techniques or “standard likelihood fusion” with the probability distribution of ToAs obtained without using the ML techniques).

In this non-limiting example (which is a ML model-based likelihood fusion), based on the probability distribution of ToAs 1160, the LOS ToA probability distribution 1162 and the NLOS ToA probability distribution 1164 may be depicted as probability distributions of estimated ranges 1136 and 1138, respectively. Moreover, the ToA probability distributions regarding the signals from the second TRP 1140 and the third TRP 1150 may be depicted as probability distributions of estimated ranges 1146 and 1156, respectively. In this non-limiting example, a positioning procedure may be performed based on combining the likelihood estimates (e.g., probability distributions of estimated ranges 1136, 1138, 1146, and 1156) across the anchor devices (e.g., the TRPs 1130, 1140, and 1150) in a soft-fusion manner to determine the estimated location of the target device. As the impact of the NLOS signal from the first TRP 1130 may be reduced by converting the channel response 1110 to the probability distribution of ToAs 1160, the probability distribution of estimated ranges 1136 would be considered, and the estimated location of the target device may be closer to the true location 1122 than the example of FIG. 11A.

While the examples illustrated with reference to FIGS. 7-11C are based on using TRPs as anchor devices for determining the estimated location of a target device (e.g., a UE), similar positioning procedures may be implemented based on any anchor devices of different communication technologies to enhance the position estimation performance. In certain environments, a target device may be able to perform measurements with several anchor devices of different RATs (including different communication technologies and/or different versions of a communication technology lineage). In some aspects, the anchor devices may be one or more TRPs, one or more UEs, one or more roadside units (RSUs), one or more access points (APs), or any combination thereof.

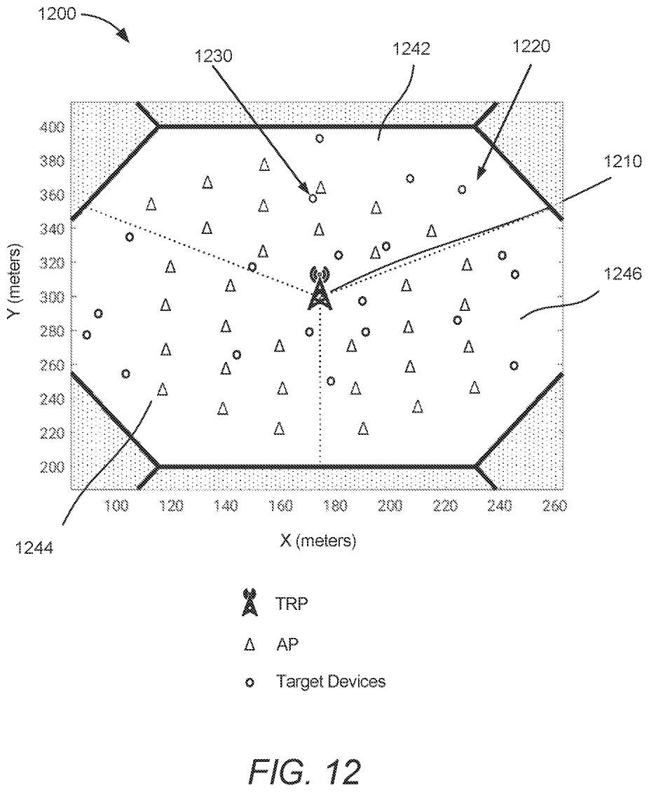

FIG. 12 is a diagram illustrating an indoor environment 1200 that includes a TRP 1210 based on a first RAT (e.g., LTE or 5G) and a plurality of APs based on a second RAT (e.g., Wi-Fi or Bluetooth), according to aspects of the disclosure. The TRP 1210 provides the services in the cell 1220 (the octagon area that is not shaded) based on the first RAT. In addition, a plurality of target devices may be presented in the indoor environment 1200. In some aspects, some of the target devices may be capable of communicating with the TRP and the APs, while some of the target devices may be capable of communicating with only the TRP or only the APs. Also, the indoor environment 1200 is used as a non-limiting example. In some aspects, the challenges and solutions illustrated based on the indoor environment 1200 may be applicable to an outdoor environment or a combined indoor-outdoor environment.

In the non-limiting example as shown in FIG. 12, a target device 1230 in the indoor environment 1200 may engage in a RFFP-based positioning procedure with a set of anchor devices, including the TRP 1210, one or more APs in the indoor environment 1200, one or more other TRPs outside the indoor environment 1200 (not shown), and/or one or more APs outside the indoor environment 1200 (not shown). However, due to the physical settings (e.g., based on walls, windows, furniture, fixtures, etc.) and channel characteristics (e.g., based on materials, temperature, moisture, interferences, etc.) in the indoor environment 1200, not every AP disposed in the cell 1220 may be observable by the target device 1230 or may actually improve the precision of the positioning procedure. Also, the more APs considered in the positioning procedure, the more complex and computational demanding the positioning procedure and the machine learning technique (including the training phase and the inferring phase) would likely be.

Therefore, in the non-limiting example as shown in FIG. 12, the APs disposed in the cell 1220 may be arranged into three groups, including the APs in regions 1242, 1244, and 1246, respectively. Each group of APs together with the TRP 1210 may better serve the positioning of a target device in the respective region. Accordingly, a specific combination of anchor devices may be mapped to the use of a respective (even tailored or unique) ML model that is configured to operate over the specific combination of anchor devices. In some aspects, a target device or a location server that engages in a positioning procedure to determine an estimated location of the target device may identify a set of observable anchor devices and/or a suitable ML model for the set of observable anchor devices for the positioning procedure as further illustrated below.

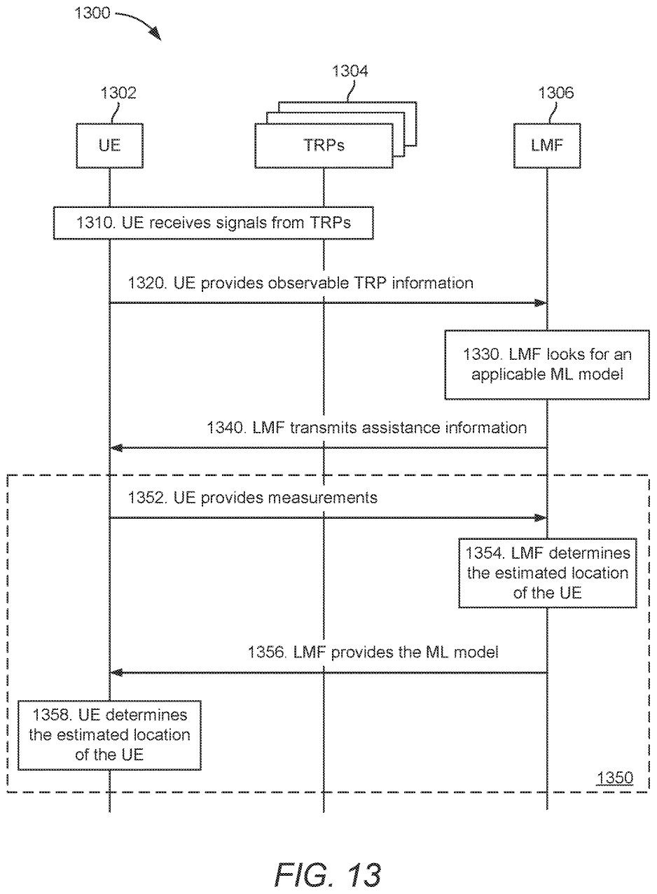

FIG. 13 illustrates an example process flow 1300 for enabling the use of an ML model that corresponds to a set of TRPs observable by a UE, according to aspects of the disclosure. In this non-limiting example, the UE 1302 (e.g., any of the UE described herein) may first provide the LMF 1306 (e.g., the LMF 270 or any of the location server described herein) with a list of TRPs 1304 (e.g., any of the base station or TRP described herein) that are observable by the UE (e.g., the TRPs that the UE may properly perform measurements of the signals therefrom, or the TRPs corresponding to having the measurements exceeding a value). The LMF 1306 may then direct the UE 1302 to use a ML model that corresponds to the set of TRPs 1304 or fall back to a positioning procedure that is not based on the ML model (e.g., any of the positioning procedures illustrated with reference to FIG. 4 or the “standard likelihood fusion” in FIG. 11).

At stage 1310, the UE 1302 may receive signals from the TRPs 1304. In some aspects, the signals may include reference signals (e.g., DL-PRS or channel state information reference signal (CSI-RS)) or control or data signals (e.g., physical channel signals that carries RRC configuration information). The UE may compile a set of TRPs that is considered observable by the UE 1302 for a positioning procedure.

At stage 1320, the UE may transmit, and the LMF 1306 may thus receive, observable TRP information that indicates the set of TRPs observable by the UE 1302. In some aspects, the observable TRP information may indicate a list of the set of observable TRPs, a cell identifier corresponding to the set of observable TRPs, or a group identifier corresponding to the set of observable TRPs.

At stage 1330, the LMF 1306 may look for an applicable ML model that may correspond to the set of observable TRPs indicated in the observable TRP information. In some aspects, the LMF 1306 may maintain a record of one or more candidate ML models that respectively correspond to one or more candidate sets of TRPs. The LMF 1306 may check if one of the candidate ML models is applicable to the set of observable TRPs provided by the UE 1302. In some aspects, a candidate ML model may be considered as applicable to the set of observable TRPs if the corresponding candidate set of TRPs matches the set of observable TRPs. In some aspects, a candidate ML model may be considered as applicable to the set of observable TRPs if the corresponding candidate set of TRPs is a superset of the set of observable TRPs.

At stage 1340, the LMF 1306 may transmit, and the UE 1302 may receive, assistance information for the positioning procedure. In some aspects, if the LMF 1306 successfully identifies the applicable ML model corresponding to the set of observable TRPs, the assistance information may indicate the identified ML model corresponding to the set of observable TRPs. In some aspects, the assistance information may provide the ML model, a model identifier of the ML model, or both. In some aspects, if the positioning procedure is a UE-assisted positioning procedure, the LMF 1306 may include in the assistance information a request to the UE 1302 asking the UE 1302 to provide measurements for the positioning procedure (and optionally without indicating the identified ML model).

However, in some aspects, if the LMF 1306 cannot identify the applicable ML model corresponding to the set of observable TRPs, the assistance information may indicate the unavailability of an suitable ML model, direct the UE to engage in a positioning procedure that does not require the ML model, or a combination thereof (e.g., the “standard likelihood fusion” without using the ML techniques or other methods illustrated with reference to FIG. 4). In some aspects, if the positioning procedure is a UE-assisted positioning procedure, the LMF 1306 may include in the assistance information a request to the UE 1302 asking the UE 1302 to provide measurements for the positioning procedure.

At stage 1350 (including 1352 and 1354, or 1356 and 1358), the UE 1302 may engage in a positioning procedure that is based on the ML model with at least a subset of the set of observable TRPs for determining an estimated location of the UE 1302. In some aspects, stages 1352 and 1354 correspond to the positioning procedure being a UE-assisted positioning procedure. In some aspects, stages 1356 and 1358 correspond to the positioning procedure being a UE-based positioning procedure.

In the case that the UE-assisted positioning procedure is performed, at stage 1352, the UE may obtain measurements (e.g., CIR, ToA, AoA, etc.) of signals between the UE 1302 and at least the subset of the set of observable TRPs. At stage 1352, the UE 1302 may transmit, and the LMF 1306 may receive, the measurements. In some aspects, the measurements may be provided in response to the request included in the assistance information at stage 1340.

At stage 1354, the LMF 1306 may determine the estimated location of the UE 1302 based on applying the identified ML model to the received measurements. In some aspects, the LMF 1306 may also use some a-priori information specific to a region corresponding to the set of observable TPRs (that may be derived from other UEs previously located in the region) as input to the ML model. In some aspects, the LMF 1306 may further provide the estimated location of the UE 1302 to the UE 1302.

In the case that the UE-based positioning procedure is performed, at stage 1356, the LMF 1306 may provide the ML model. In some aspects, the UE 1302 may send a request to the LMF 1306 at stage 1356, and the LMF 1306 may provide the ML model in response to the request. In some aspects, the LMF 1306 may have provided the ML model at stage 1340 or the UE 1302 may have downloaded the ML model prior to stage 1352, and the UE 1302 may simply load the stored ML model at stage 1352.

In some aspects, the LMF 1306 may provide the UE 1302 some a-priori information specific to a region corresponding to the set of observable TPRs to be used as input to the ML model. In some aspects, the LMF 1306 may access the ML model stored locally in the LMF 1306 or stored remotely in a database outside the LMF 1306. In some aspects, the LMF 1306 may indicate the model identifier of the ML model, and the UE 1302 may request and obtain the ML model based on the model identifier from a server that is different from the LMF 1306.

At stage 1358, the UE 1302 may obtain measurements (e.g., CIR, ToA, AoA, etc.) of signals between the UE 1302 and at least the subset of the set of observable TRPs and determine the estimated location of the UE 1302 based on applying the ML model to the obtained measurements. In some aspects, the UE 1302 may also use the a-priori information provided by the LMF 1306 as input to the ML model. In some aspects, the UE 1302 may further provide the estimated location of the UE 1302 to the LMF 1306.

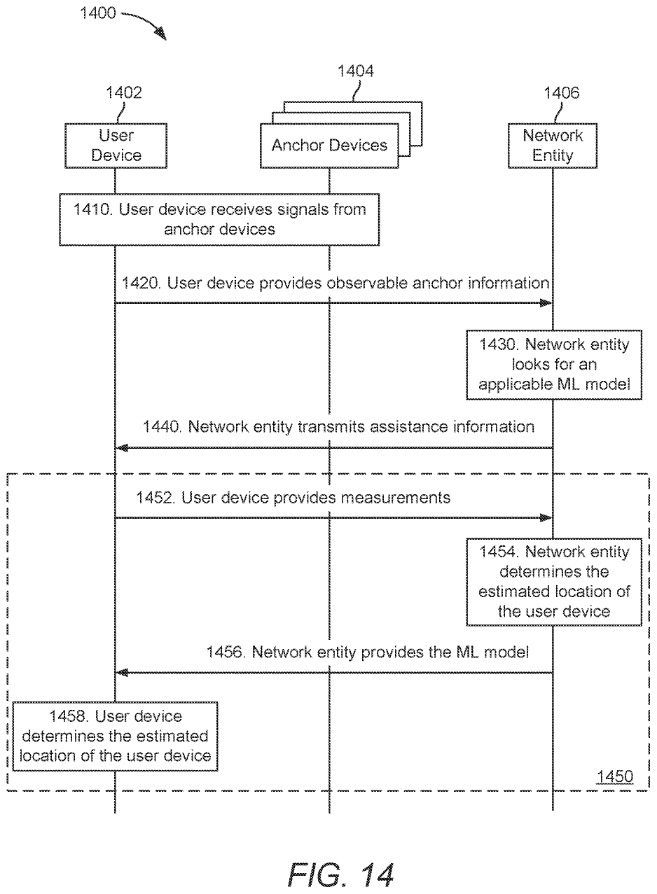

FIG. 14 illustrates an example process flow 1400 for enabling the use of an ML model that corresponds to a set of anchor devices observable by a user device, according to aspects of the disclosure. The process flow 1400 may be considered as an extension or a variation of the process flow 1300 as shown in FIG. 13. Compared with the example shown in FIG. 13, the UE 1302 may be replaced by a user device 1402; the TRPs 1304 may be replaced by anchor devices 1404; and the LMF 1306 may be replaced by a network entity 1406.

In some aspects, the user device 1402 may be a UE that supports communication with a TRP. In some aspects, the user device 1402 may be any communication device that is capable of communicating with one or more anchor devices based on one or more communication standards, such as any wireless communication technologies described in this disclosure. In some aspects, the anchor devices 1404 may include one or more TRPs, one or more UEs, one or more RSUs, one or more APs, or any combination thereof.

In some aspects, the network entity 1406 may be an LMF. In some aspects, the network entity 1406 may be any server that can support ML-based positioning, such as a proprietary server or a connected intelligent edge (CIE) server. In some aspects, the network entity 1406 may store the ML model or may have access to a database that stores the ML model.

In some aspects, as the process flow 1400 may be considered as an extension or a variation of the process flow 1300 as shown in FIG. 13, and the operations of stages 1410, 1420, 1430, 1440, and 1450 (including stages 1452 and 1454 or 1456 and 1458) may be the same or similar to the operations of stages 1310, 1320, 1330, 1340, and 1350 (including stages 1352 and 1354 or 1356 and 1358), respectively. Accordingly, detailed description of various stages in FIG. 14 may be omitted. Some additional details regarding the process flow 1400 are illustrated below.

In some aspects, at stage 1410, the user device 1402 may receive signals from the anchor devices 1404. In some aspects, the signals may include reference signals (e.g., DL-PRS, CSI-RS, pilot sequence, beacons, etc.), control signals, or data signals.

In some aspects, at stage 1420, the user device 1402 may transmit the observable anchor information to the network entity 1406, where the observable anchor information may indicate a set of anchor devices (e.g., the anchor devices 1404) observable by the user device 1402. In some aspects, the set of anchor devices may be indicated based on identifying information of the anchor devices, such as cell identifiers, MAC identifiers, types of communication technology, application layer data, or any combination thereof.

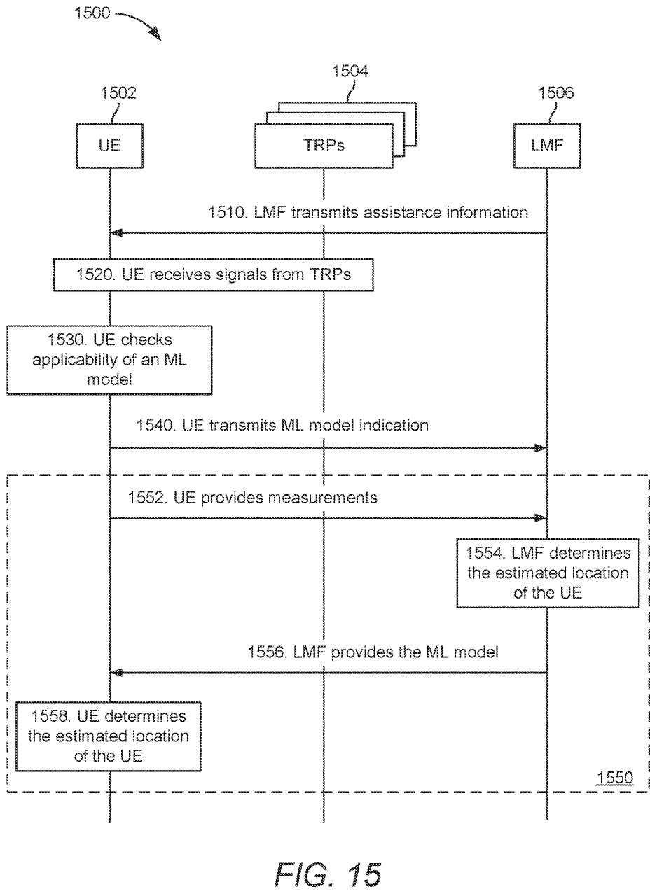

FIG. 15 illustrates an example process flow 1500 for enabling the use of an ML model from one or more candidate ML models corresponding to one or more candidate sets of TRPs, according to aspects of the disclosure. In this non-limiting example, an LMF 1506 (e .g., the LMF 270 or any of the location server described herein) may maintain a table of candidate ML models corresponding to candidate sets of TRPs for positioning procedures. A UE 1502 (e.g., any of the UE described herein) may provide device information of the UE (e.g., a coarse location, such as a location that the UE's actual location is no farther away than a tolerance, or a cell identifier of the cell that serves the UE) to the LMF 1506. Based on the device information, the LMF may transmit assistance information that indicates the one or more candidate ML models corresponding to the one or more candidate sets of TRPs. The UE 1502 (e.g., any of the UE described herein) then may select a ML model from the one or more candidate ML models for positioning based on the TRPs 1504 (e.g., any of the base station or TRP described herein) observable by the UE.

At stage 1510, the LMF 1506 may transmit, and the UE 1502 thus may receive, assistance information for positioning. The assistance information indicates one or more candidate ML models corresponding to respective one or more candidate sets of TRPs. In some aspects, the assistance information may be from the LMF 1506 via broadcasting, multicasting, or unicasting. In some aspects, the assistance information may indicate model identifiers of the one or more candidate ML models.

At stage 1520, the UE 1502 may receive signals from the TRPs 1504. In some aspects, the signals may include reference signals (e.g., DL-PRS or CSI-RS) or control or data signals (e.g., physical channel signals that carries RRC configuration information). The UE 1502 may compile a set of TRPs that is considered observable by the UE 1502 based on signal coverage, signal strength, and/or signal quality of the signals from the TRPs 1504.

At stage 1530, the UE 1502 may select a ML model from the one or more candidate ML models based on the set of observable TRPs 1504. In some aspects, a candidate ML model may be selected if the corresponding candidate set of TRPs matches the set of observable TRPs. In some aspects, a candidate ML model may be selected if the corresponding candidate set of TRPs is a superset of the set of observable TRPs.

At stage 1540, the UE 1502 may transmit, and the LMF 1506 may receive, a ML model indication indicating the selected ML model (or the lack of the selected ML model if there is no suitable candidate ML model). In some aspects, if the UE 1502 selected a suitable ML model corresponding to the set of observable TRPs, the ML model indication may provide a model identifier of the selected ML model. In some aspects, if the positioning procedure is a UE-based positioning procedure and the UE already obtains the selected ML model, stage 1540 may be omitted. However, in some aspects, if the UE 1502 did not select any suitable ML model, the ML model indication may indicate the unavailability of the suitable ML model, in which case the UE 1502 may subsequently engage in a positioning procedure that does not require the ML model (e.g., the “standard likelihood fusion” without using the machine learning technique or other methods illustrated with reference to FIG. 4).

At stage 1550 (including 1552 and 1554, or 1556 and 1558), the UE 1502 may engage in a positioning procedure that is based on the selected ML model with at least a subset of the set of observable TRPs 1504 for determining an estimated location of the UE 1502. In some aspects, stages 1552 and 1554 correspond to the positioning procedure being a UE-assisted positioning procedure. In some aspects, stages 1556 and 1558 correspond to the positioning procedure being a UE-based positioning procedure. The operations of stage 1552 and 1554 may be similar to the operations of stages 1352 and 1354 in FIG. 13, and detailed description thereof is thus omitted. Also, the operations of stage 1556 and 1558 may be similar to the operations of stages 1356 and 1358 in FIG. 13, and detailed description thereof is thus omitted.

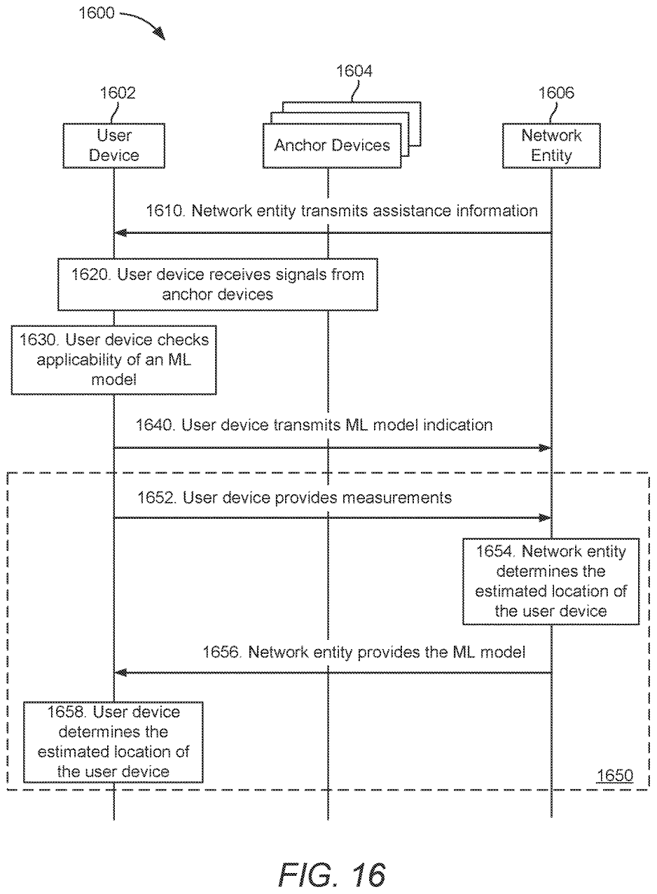

FIG. 16 illustrates an example process flow for enabling the use of an ML model from one or more candidate ML models corresponding to one or more candidate sets of anchor devices, according to aspects of the disclosure. The process flow 1600 may be considered as an extension or a variation of the process flow 1500 as shown in FIG. 15. Compared with the example shown in FIG. 15, the UE 1502 may be replaced by a user device 1602; the TRPs 1504 may be replaced by anchor devices 1604; and the LMF 1506 may be replaced by a network entity 1606.

In some aspects, the user device 1602 may be a UE that supports communication with a TRP. In some aspects, the user device 1602 may be any communication device that is capable of communicating with one or more anchor devices based on one or more communication standards, such as any wireless communication technologies described in this disclosure. In some aspects, the anchor devices 1604 may include one or more TRPs, one or more UEs, one or more RSUs, one or more APs, or any combination thereof.

In some aspects, the network entity 1606 may be an LMF. In some aspects, the network entity 1606 may be a server that can support ML-based positioning, such as a proprietary server or a connected intelligent edge (CIE) server. In some aspects, the network entity 1606 may store the one or more candidate ML models or may have access to a database that stores the one or more candidate ML models.

In some aspects, as the process flow 1600 may be considered as an extension or a variation of the process flow 1500 as shown in FIG. 15, the operations of stages 1610, 1620, 1630, 1640, and 1650 (including stages 1652 and 1654 or 1656 and 1658) may be the same or similar to the operations of stages 1510, 1520, 1530, 1540, and 1550/1350 (including stages 1552/1352 and 1554/1354 or 1556/1356 and 1558/1358), respectively.

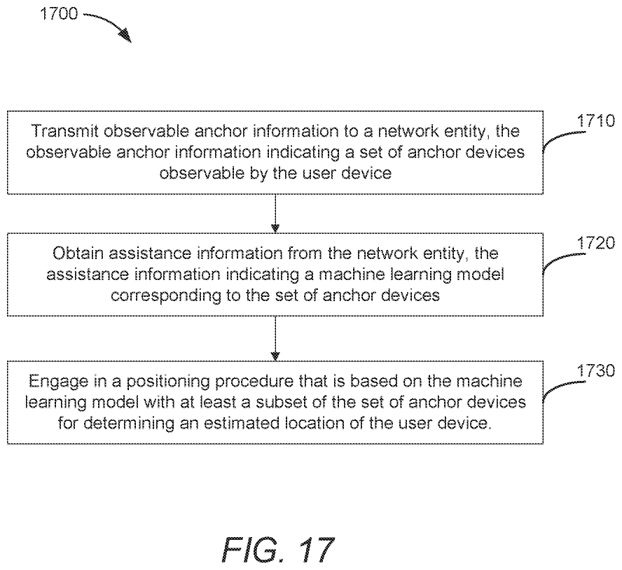

FIG. 17 illustrates an example method 1700 of operating a user device, according to aspects of the disclosure. In some aspects, the method 1700 may be performed by a UE (e.g., any of the UE described herein). In some aspects, method 1700 may correspond to the operations performed by the UE 1302 in FIG. 13 or the user device 1402 in FIG. 14. In an aspect, method 1700 may be performed by the one or more WWAN transceivers 310, the one or more processors 332, memory 340, and/or positioning component 342, any or all of which may be considered means for performing one or more of the following operations of method 1700.

At operation 1710, the user device can transmit observable anchor information to a network entity. The observable anchor information may indicate a set of anchor devices observable by the user device. In some aspects, the observable anchor information may indicate a list of the set of anchor devices, a cell identifier corresponding to the set of anchor devices, or a group identifier corresponding to the set of anchor devices. In some aspects, the set of anchor devices may include one or more TRPs, one or more UEs, one or more RSUs, one or more APs, or any combination thereof. In some aspects, operation 1710 may be performed by the one or more WWAN transceivers 310, the one or more processors 332, memory 340, and/or positioning component 342, any or all of which may be considered means for performing operation 1710.

At operation 1720, the user device can obtain assistance information from the network entity. The assistance information may indicate a ML model corresponding to the set of anchor devices. In some aspects, the assistance information may provide the ML model, a model identifier of the ML model, or both. In some aspects, operation 1720 may be performed by the one or more WWAN transceivers 310, the one or more processors 332, memory 340, and/or positioning component 342, any or all of which may be considered means for performing operation 1720.

At operation 1730, the user device can engage in a positioning procedure that is based on the ML model with at least a subset of the set of anchor devices for determining an estimated location of the user device. In some aspects, operation 1730 may be performed by the one or more WWAN transceivers 310, the one or more processors 332, memory 340, and/or positioning component 342, any or all of which may be considered means for performing operation 1730.

In some aspects, when the positioning procedure is a user device based positioning procedure, the user device may obtain measurements of signals between the user device and at least the subset of the set of anchor devices, and apply the ML model to the measurements to obtain the estimated location of the user device. In some aspects, the user device may receive the ML model from the network entity or a server device different from the network entity.

In some aspects, when the positioning procedure is a user device assisted positioning procedure, the user device may obtain measurements of signals between the user device and the subset of the set of anchor devices, and transmit the measurements to the network entity. The network entity may apply the ML model to the measurements to obtain the estimated location of the user device.

As will be appreciated, a technical advantage of the method 1700 is directed to obtaining from a network entity an ML model that is specific for a set of observable anchor devices. Each set of anchor devices may be associated with a specific ML model that is optimized to operate over the corresponding set of anchor devices. As a result of the optimization, not all anchor devices present in an environment are needed to be considered by the ML model specific for the set of observable anchor devices. Based on the obtained ML model, a ML-based positioning procedure may be performed with improved performance from balancing the factors of precision of the estimated location and the computational complexity of the ML model. Also, a user device may obtain an ML model that is optimized for the set of anchor devices observable by the user device.

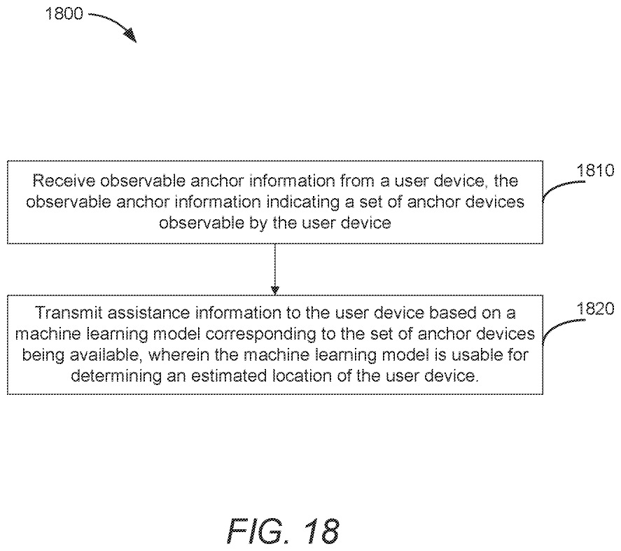

FIG. 18 illustrates an example method 1800 of operating a network entity, according to aspects of the disclosure. In some aspects, the method 1800 may be performed by a server device (e.g., any of the location server, LMF, SLP, proprietary server, CIE server, or server described herein). In some aspects, method 1800 may correspond to the operations performed by the LMF 1306 in FIG. 13 or the network entity 1406 in FIG. 14. In an aspect, method 1800 may be performed by the one or more network transceivers 398, the one or more processors 394, memory 398, and/or positioning component 398, any or all of which may be considered means for performing one or more of the following operations of method 1800.

At operation 1810, the network entity can receive observable anchor information from a user device. The observable anchor information may indicate a set of anchor devices observable by the user device. In some aspects, the observable anchor information may indicate a list of the set of anchor devices, a cell identifier corresponding to the set of anchor devices, or a group identifier corresponding to the set of anchor devices. In some aspects, the set of anchor devices may include one or more TRPs, one or more UEs, one or more RSUs, one or more APs, or any combination thereof. In some aspects, operation 1810 may be performed by the one or more network transceivers 398, the one or more processors 394, memory 398, and/or positioning component 398, any or all of which may be considered means for performing operation 1810.

At operation 1820, the network entity can transmit assistance information to the user device based on a ML model corresponding to the set of anchor devices being available, In some aspects, the ML model is usable for determining an estimated location of the user device. In some aspects, the assistance information may provide the ML model, a model identifier of the ML model, or both. In some aspects, operation 1820 may be performed by the one or more network transceivers 398, the one or more processors 394, memory 398, and/or positioning component 398, any or all of which may be considered means for performing operation 1820.

In some aspects, after operation 1820, the network entity may engage in a user device assisted positioning procedure, which may include receiving, from the user device, measurements of signals between the user device and at least a subset of the set of anchor devices, and applying the ML model to the measurements to obtain the estimated location of the user device.

As will be appreciated, a technical advantage of the method 1800 is directed to providing to a user device an ML model that is specific for a set of observable anchor devices. Each set of anchor devices may be associated with a specific ML model that is optimized to operate over the corresponding set of anchor devices. As a result of the optimization, not all anchor devices present in an environment are needed to be considered by the ML model specific for the set of observable anchor devices. Based on the provided ML model, a ML-based positioning procedure may be performed with improved performance from balancing the factors of precision of the estimated location and the computational complexity of the ML model. Also, the network entity may provide the user device at least an ML model that is optimized for the set of anchor devices observable by the user device.

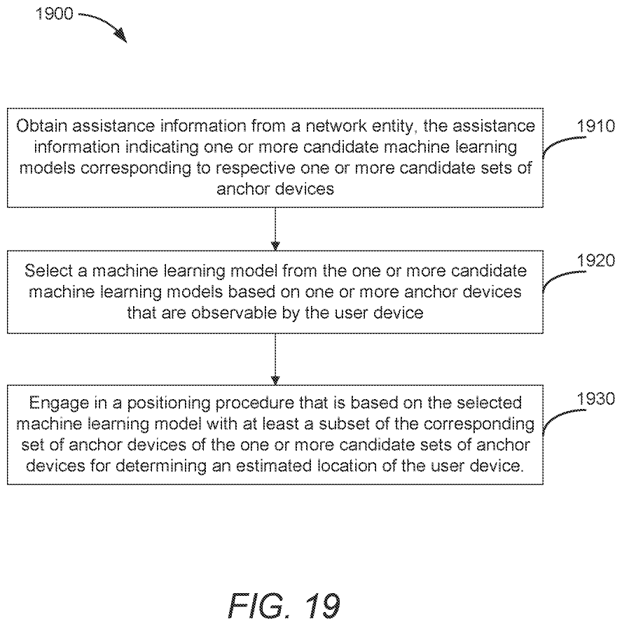

FIG. 19 illustrates an example method 1900 of operating a user device, according to aspects of the disclosure. In some aspects, the method 1900 may be performed by a UE (e.g., any of the UE described berein). In some aspects, method 1900 may correspond to the operations performed by the UE 1502 in FIG. 15 or the user device 1602 in FIG. 16. In an aspect, method 1900 may be performed by the one or more WWAN transceivers 310, the one or more processors 332, memory 340, and/or positioning component 342, any or all of which may be considered means for performing one or more of the following operations of method 1900.

At operation 1910, the user device can obtain assistance information from a network entity. The assistance information may indicate one or more candidate ML models corresponding to respective one or more candidate sets of anchor devices. In some aspects, the assistance information may be received from the network entity via broadcasting, multicasting, or unicasting. In some aspects, the assistance information may indicate model identifiers of the one or more candidate ML models. In some aspects, the one or more candidate sets of anchor devices may include one or more TRPs, one or more UEs, one or more RSUs, one or more APs, or any combination thereof. In some aspects, operation 1910 may be performed by the one or more WWAN transceivers 310, the one or more processors 332, memory 340, and/or positioning component 342, any or all of which may be considered means for performing operation 1910.

At operation 1920, the user device can select a ML model from the one or more candidate ML models based on one or more anchor devices that are observable by the user device. In some aspects, operation 1920 may be performed by the one or more WWAN transceivers 310, the one or more processors 332, memory 340, and/or positioning component 342, any or all of which may be considered means for performing operation 1920.

At operation 1930, the user device can engage in a positioning procedure that is based on the selected ML model with at least a subset of the corresponding set of anchor devices of the one or more candidate sets of anchor devices for determining an estimated location of the user device. In some aspects, operation 1930 may be performed by the one or more WWAN transceivers 310, the one or more processors 332, memory 340, and/or positioning component 342, any or all of which may be considered means for performing operation 1930.

In some aspects, when the positioning procedure is a user device based positioning procedure, the user device may obtain measurements of signals between the user device and at least the subset of the corresponding set of anchor devices, and apply the selected ML model to the measurements to obtain the estimated location of the user device. In some aspects, the user device may receive the selected ML model from the network entity or a server device different from the network entity.

In some aspects, when the positioning procedure is a user device assisted positioning procedure, the user device may obtain measurements of signals between the user device and at least the subset of the corresponding set of anchor devices, and transmit the measurements to the network entity. The network entity may apply the selected ML model to the measurements to obtain the estimated location of the user device.

As will be appreciated, a technical advantage of the method 1900 is directed to obtaining from a network entity one or more candidate ML models and selecting from the candidate ML models a suitable ML model that is specific for a set of observable anchor devices. Therefore, not all anchor devices present in an environment are needed to be considered by the selected ML model. The user device may have the flexibility of selecting an ML model, based on the set of anchor devices observable by the user device, Based on the selected ML model, a ML-based positioning procedure may be performed with improved performance from balancing the factors of precision of the estimated location and the computational complexity of the ML model. Additionally, the user device may proactively perform measurements with only the set of anchor devices corresponding to the selected ML model. This can reduce time/energy costs as the user device may omit performing measurements with other anchor devices (that are not associated with the ML model).

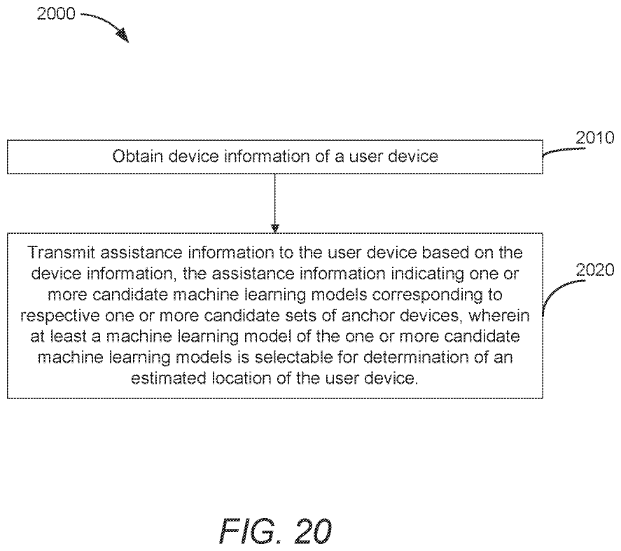

FIG. 20 illustrates an example method 2000 of operating a network entity, according to aspects of the disclosure. In some aspects, the method 2000 may be performed by a server device (e.g., any of the location server, LMF, SLP, proprietary server, CIE server, or server described herein). In some aspects, method 2000 may correspond to the operations performed by the LMF 1506 in FIG. 15 or the network entity 1606 in FIG. 16. In an aspect, method 2000 may be performed by the one or more network transceivers 398, the one or more processors 394, memory 398, and/or positioning component 398, any or all of which may be considered means for performing one or more of the following operations of method 2000.

At operation 2010, the network entity can obtain device information of a user device. In some aspects, the device information may indicate a coarse location of the user device (e.g., based on a location that the user device's actual location is no farther away than a tolerance, or a cell/AP identifier of the cell/AP that serves the user device). In some aspects, operation 2010 may be performed by the one or more network transceivers 398, the one or more processors 394, memory 398, and/or positioning component 398, any or all of which may be considered means for performing operation 2010.

At operation 2020, the network entity can transmit assistance information to the user device based on the device information. In some aspects, the assistance information may indicate one or more candidate ML models corresponding to respective one or more candidate sets of anchor devices. In some aspects, at least a ML model of the one or more candidate ML models is selectable for determination of an estimated location of the user device. In some aspects, operation 2020 may be performed by the one or more network transceivers 398, the one or more processors 394, memory 398, and/or positioning component 398, any or all of which may be considered means for performing operation 2020.

In some aspects, the assistance information may be transmitted by the network entity via broadcasting, multicasting, or unicasting. In some aspects, the assistance information may indicate model identifiers of the one or more candidate ML models.

In some aspects, after operation 2020, the network entity may obtain an indication from the user device, and the indication may indicate the selected ML model of the one of the one or more candidate ML models for determining the estimated location of the user device. In some aspects, the network entity may transmit the ML model of the one or more candidate ML models to the user device in response to the indication.

In some aspects, after operation 2020, the network entity may engage in a user device assisted positioning procedure, which may include receiving, from the user device, measurements of signals between the user device and at least a subset of the corresponding set of anchor devices of the one or more candidate sets of anchor devices that corresponds to the ML model, and applying the ML model to the measurements to obtain the estimated location of the user device.

As will be appreciated, a technical advantage of the method 2000 is directed to providing to a user device one or more candidate ML models, such that the user device may select from the candidate ML models a suitable ML model that is specific for a set of observable anchor devices. Therefore, not all anchor devices present in an environment are needed to be considered by the selected ML model. Based on the selected ML model, a ML-based positioning procedure may be performed with improved performance from balancing the factors of precision of the estimated location and the computational complexity of the ML model.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user device, comprising: transmitting observable anchor information to a network entity, the observable anchor information indicating a set of anchor devices observable by the user device; obtaining assistance information from the network entity, the assistance information indicating a machine learning model corresponding to the set of anchor devices; and engaging in a positioning procedure that is based on the machine learning model with at least a subset of the set of anchor devices for determining an estimated location of the user device.

Clause 2. The method of clause 1, wherein the assistance information provides the machine learning model, a model identifier of the machine learning model, or both.

Clause 3. The method of any of clauses 1 to 2, wherein the observable anchor information indicates a list of the set of anchor devices, a cell identifier corresponding to the set of anchor devices, or a group identifier corresponding to the set of anchor devices.

Clause 4. The method of any of clauses 1 to 3, wherein the engaging in the positioning procedure comprises: obtaining measurements of signals between the user device and at least the subset of the set of anchor devices; and applying the machine learning model to the measurements to obtain the estimated location of the user device.

Clause 5. The method of any of clauses 1 to 4, further comprising: receiving the machine learning model from the network entity or a server device different from the network entity.

Clause 6. The method of any of clauses 1 to 3, wherein the engaging in the positioning procedure comprises: obtaining measurements of signals between the user device and the subset of the set of anchor devices; and transmitting the measurements to the network entity.

Clause 7. The method of any of clauses 1 to 6, wherein the set of anchor devices includes: one or more transmission-reception points (TRPs), one or more user equipments (UEs), one or more roadside units (RSUs), one or more access points (APs), or any combination thereof.

Clause 8. A method of wireless communication performed by a network entity, comprising: receiving observable anchor information from a user device, the observable anchor information indicating a set of anchor devices observable by the user device; and transmitting assistance information to the user device based on a machine learning model corresponding to the set of anchor devices being available, wherein the machine learning model is usable for determining an estimated location of the user device.

Clause 9. The method of clause 8, wherein the observable anchor information indicates a list of the set of anchor devices, a cell identifier corresponding to the set of anchor devices, or a group identifier corresponding to the set of anchor devices.

Clause 10. The method of any of clauses 8 to 9, wherein the assistance information provides the machine learning model, a model identifier of the machine learning model, or both.

Clause 11. The method of any of clauses 8 to 10, further comprising: receiving, from the user device, measurements of signals between the user device and at least a subset of the set of anchor devices; and applying the machine learning model to the measurements to obtain the estimated location of the user device.

Clause 12. The method of any of clauses 8 to 11, wherein the set of anchor devices includes: one or more transmission-reception points (TRPs), one or more user equipments (UEs), one or more roadside units (RSUs), one or more access points (APs), or any combination thereof.

Clause 13. A method of wireless communication performed by a user device, comprising: obtaining assistance information from a network entity, the assistance information indicating one or more candidate machine learning models corresponding to respective one or more candidate sets of anchor devices; selecting a machine learning model from the one or more candidate machine learning models based on a set of anchor devices that are observable by the user device; and engaging in a positioning procedure that is based on the selected machine learning model with at least a subset of the corresponding set of anchor devices of the one or more candidate sets of anchor devices for determining an estimated location of the user device.

Clause 14. The method of clause 13, wherein the assistance information is received from the network entity via broadcasting, multicasting, or unicasting.

Clause 15. The method of any of clauses 13 to 14, wherein the assistance information indicates model identifiers of the one or more candidate machine learning models.

Clause 16. The method of any of clauses 13 to 15, wherein the engaging in the positioning procedure comprises: obtaining measurements of signals between the user device and at least the subset of the corresponding set of anchor devices; and applying the selected machine learning model to the measurements to obtain the estimated location of the user device.

Clause 17. The method of any of clauses 13 to 16, further comprising: receiving the selected machine learning model from the network entity or a server device different from the network entity.

Clause 18. The method of any of clauses 13 to 15, wherein the engaging in the positioning procedure comprises: obtaining measurements of signals between the user device and at least the subset of the corresponding set of anchor devices; and transmitting the measurements to the network entity.

Clause 19. The method of any of clauses 13 to 18, wherein the one or more candidate sets of anchor devices include: one or more transmission-reception points (TRPs), one or more user equipments (UEs), one or more roadside units (RSUs), one or more access points (APs), or any combination thereof.

Clause 20. A method of wireless communication performed by a network entity, comprising: obtaining device information of a user device; and transmitting assistance information to the user device based on the device information, the assistance information indicating one or more candidate machine learning models corresponding to respective one or more candidate sets of anchor devices, wherein at least a machine learning model of the one or more candidate machine learning models is selectable for determination of an estimated location of the user device.

Clause 21. The method of clause 20, wherein the device information indicating a coarse location of the user device.

Clause 22. The method of any of clauses 20 to 21, wherein the assistance information is transmitted by the network entity via broadcasting, multicasting, or unicasting.

Clause 23. The method of any of clauses 20 to 22, wherein the assistance information indicates model identifiers of the one or more candidate machine learning models.

Clause 24. The method of any of clauses 20 to 23, further comprising: obtaining an indication from the user device, the indication indicating the machine learning model of the one of the one or more candidate machine learning models for determining the estimated location of the user device.

Clause 25. The method of clause 24, further comprising: transmitting the machine learning model of the one or more candidate machine learning models to the user device in response to the indication.

Clause 26. The method of any of clauses 24 to 25, further comprising: receiving, from the user device, measurements of signals between the user device and at least a subset of the corresponding set of anchor devices of the one or more candidate sets of anchor devices that corresponds to the machine learning model; and applying the machine learning model to the measurements to obtain the estimated location of the user device.

Clause 27. The method of any of clauses 20 to 26, wherein the one or more candidate sets of anchor devices include: one or more transmission-reception points (TRPs), one or more user equipments (UEs), one or more roadside units (RSUs), one or more access points (APs), or any combination thereof.

Clause 28. A user device, comprising: a memory; at least one transceiver; and at least one processor communicatively coupled to the memory and the at least one transceiver, the at least one processor configured to: transmit, via the at least one transceiver, observable anchor information to a network entity, the observable anchor information indicating a set of anchor devices observable by the user device; obtain assistance information from the network entity, the assistance information indicating a machine learning model corresponding to the set of anchor devices; and engage in a positioning procedure that is based on the machine learning model with at least a subset of the set of anchor devices for determining an estimated location of the user device.

Clause 29. The user device of clause 28, wherein the assistance information provides the machine learning model, a model identifier of the machine learning model, or both.

Clause 30. The user device of any of clauses 28 to 29, wherein the observable anchor information indicates a list of the set of anchor devices, a cell identifier corresponding to the set of anchor devices, or a group identifier corresponding to the set of anchor devices.

Clause 31. The user device of any of clauses 28 to 30, wherein the at least one processor configured to engage in the positioning procedure is further configured to: obtain measurements of signals between the user device and at least the subset of the set of anchor devices; and apply the machine learning model to the measurements to obtain the estimated location of the user device.

Clause 32. The user device of any of clauses 28 to 31, wherein the at least one processor is further configured to: receive, via the at least one transceiver, the machine learning model from the network entity or a server device different from the network entity.

Clause 33. The user device of any of clauses 28 to 30, wherein the at least one processor configured to engage in the positioning procedure is further configured to: obtain measurements of signals between the user device and the subset of the set of anchor devices; and transmit, via the at least one transceiver, the measurements to the network entity.

Clause 34. The user device of any of clauses 28 to 33, wherein the set of anchor devices includes: one or more transmission-reception points (TRPs), one or more user equipments (UEs), one or more roadside units (RSUs), one or more access points (APs), or any combination thereof.

Clause 35. A network entity, comprising: a memory; at least one transceiver; and at least one processor communicatively coupled to the memory and the at least one transceiver, the at least one processor configured to: receive, via the at least one transceiver. observable anchor information from a user device, the observable anchor information indicating a set of anchor devices observable by the user device; and transmit, via the at least one transceiver, assistance information to the user device based on a machine learning model corresponding to the set of anchor devices being available, wherein the machine learning model is usable for determining an estimated location of the user device.

Clause 36. The network entity of clause 35, wherein the observable anchor information indicates a list of the set of anchor devices, a cell identifier corresponding to the set of anchor devices, or a group identifier corresponding to the set of anchor devices.

Clause 37. The network entity of any of clauses 35 to 36, wherein the assistance information provides the machine learning model, a model identifier of the machine learning model, or both.

Clause 38. The network entity of any of clauses 35 to 37, wherein the at least one processor is further configured to: receive, via the at least one transceiver, from the user device, measurements of signals between the user device and at least a subset of the set of anchor devices; and apply the machine learning model to the measurements to obtain the estimated location of the user device.

Clause 39. The network entity of any of clauses 35 to 38, wherein the set of anchor devices includes: one or more transmission-reception points (TRPs), one or more user equipments (UEs), one or more roadside units (RSUs), one or more access points (APs), or any combination thereof.

Clause 40. A user device, comprising: a memory; at least one transceiver; and at least one processor communicatively coupled to the memory and the at least one transceiver, the at least one processor configured to: obtain assistance information from a network entity, the assistance information indicating one or more candidate machine learning models corresponding to respective one or more candidate sets of anchor devices; select a machine learning model from the one or more candidate machine learning models based on a set of anchor devices that are observable by the user device; and engage in a positioning procedure that is based on the selected machine learning model with at least a subset of the corresponding set of anchor devices of the one or more candidate sets of anchor devices for determining an estimated location of the user device.

Clause 41. The user device of clause 40, wherein the assistance information is received from the network entity via broadcasting, multicasting, or unicasting.

Clause 42. The user device of any of clauses 40 to 41, wherein the assistance information indicates model identifiers of the one or more candidate machine learning models.

Clause 43. The user device of any of clauses 40 to 42, wherein the at least one processor configured to engage in the positioning procedure is further configured to: obtain measurements of signals between the user device and at least the subset of the corresponding set of anchor devices; and apply the selected machine learning model to the measurements to obtain the estimated location of the user device.

Clause 44. The user device of any of clauses 40 to 43, wherein the at least one processor is further configured to: receive, via the at least one transceiver, the selected machine learning model from the network entity or a server device different from the network entity.

Clause 45. The user device of any of clauses 40 to 42, wherein the at least one processor configured to engage in the positioning procedure is further configured to: obtain measurements of signals between the user device and at least the subset of the corresponding set of anchor devices; and transmit, via the at least one transceiver, the measurements to the network entity.

Clause 46. The user device of any of clauses 40 to 45, wherein the one or more candidate sets of anchor devices include: one or more transmission-reception points (TRPs), one or more user equipments (UEs), one or more roadside units (RSUs), one or more access points (APs), or any combination thereof.

Clause 47. A network entity, comprising: a memory; at least one transceiver; and at least one processor communicatively coupled to the memory and the at least one transceiver, the at least one processor configured to: obtain device information of a user device; and transmit, via the at least one transceiver, assistance information to the user device based on the device information, the assistance information indicating one or more candidate machine learning models corresponding to respective one or more candidate sets of anchor devices, wherein at least a machine learning model of the one or more candidate machine learning models is selectable for determination of an estimated location of the user device.

Clause 48. The network entity of clause 47, wherein the device information indicating a coarse location of the user device.

Clause 49. The network entity of any of clauses 47 to 48, wherein the assistance information is transmitted by the network entity via broadcasting, multicasting, or unicasting.

Clause 50. The network entity of any of clauses 47 to 49, wherein the assistance information indicates model identifiers of the one or more candidate machine learning models.

Clause 51. The network entity of any of clauses 47 to 50, wherein the at least one processor is further configured to: obtain an indication from the user device, the indication indicating the machine learning model of the one of the one or more candidate machine learning models for determining the estimated location of the user device.

Clause 52. The network entity of clause 51, wherein the at least one processor is further configured to: transmit, via the at least one transceiver, the machine learning model of the one or more candidate machine learning models to the user device in response to the indication.

Clause 53. The network entity of any of clauses 51 to 52, wherein the at least one processor is further configured to: receive, via the at least one transceiver, from the user device, measurements of signals between the user device and at least a subset of the corresponding set of anchor devices of the one or more candidate sets of anchor devices that corresponds to the machine learning model; and apply the machine learning model to the measurements to obtain the estimated location of the user device.

Clause 54. The network entity of any of clauses 47 to 53, wherein the one or more candidate sets of anchor devices include: one or more transmission-reception points (TRPs), one or more user equipments (UEs), one or more roadside units (RSUs), one or more access points (APs), or any combination thereof.

Clause 55. A user device, comprising: means for transmitting observable anchor information to a network entity, the observable anchor information indicating a set of anchor devices observable by the user device; means for obtaining assistance information from the network entity, the assistance information indicating a machine learning model corresponding to the set of anchor devices; and means for engaging in a positioning procedure that is based on the machine learning model with at least a subset of the set of anchor devices for determining an estimated location of the user device.

Clause 56. The user device of clause 55, wherein the assistance information provides the machine learning model, a model identifier of the machine learning model, or both.

Clause 57. The user device of any of clauses 55 to 56, wherein the observable anchor information indicates a list of the set of anchor devices, a cell identifier corresponding to the set of anchor devices, or a group identifier corresponding to the set of anchor devices.

Clause 58. The user device of any of clauses 55 to 57, wherein the means for engaging in the positioning procedure comprises: means for obtaining measurements of signals between the user device and at least the subset of the set of anchor devices; and means for applying the machine learning model to the measurements to obtain the estimated location of the user device.

Clause 59. The user device of any of clauses 55 to 58, further comprising: means for receiving the machine learning model from the network entity or a server device different from the network entity.

Clause 60. The user device of any of clauses 55 to 57, wherein the means for engaging in the positioning procedure comprises: means for obtaining measurements of signals between the user device and the subset of the set of anchor devices; and means for transmitting the measurements to the network entity.

Clause 61. The user device of any of clauses 55 to 60, wherein the set of anchor devices includes: one or more transmission-reception points (TRPs), one or more user equipments (UEs), one or more roadside units (RSUs), one or more access points (APs), or any combination thereof.

Clause 62. A network entity, comprising: means for receiving observable anchor information from a user device, the observable anchor information indicating a set of anchor devices observable by the user device; and means for transmitting assistance information to the user device based on a machine learning model corresponding to the set of anchor devices being available, wherein the machine learning model is usable for determining an estimated location of the user device.

Clause 63. The network entity of clause 62, wherein the observable anchor information indicates a list of the set of anchor devices, a cell identifier corresponding to the set of anchor devices, or a group identifier corresponding to the set of anchor devices.

Clause 64. The network entity of any of clauses 62 to 63, wherein the assistance information provides the machine learning model, a model identifier of the machine learning model, or both.

Clause 65. The network entity of any of clauses 62 to 64, further comprising: means for receiving, from the user device, measurements of signals between the user device and at least a subset of the set of anchor devices; and means for applying the machine learning model to the measurements to obtain the estimated location of the user device.

Clause 66. The network entity of any of clauses 62 to 65, wherein the set of anchor devices includes: one or more transmission-reception points (TRPs), one or more user equipments (UEs), one or more roadside units (RSUs), one or more access points (APs), or any combination thereof.

Clause 67. A user device, comprising: means for obtaining assistance information from a network entity, the assistance information indicating one or more candidate machine learning models corresponding to respective one or more candidate sets of anchor devices; means for selecting a machine learning model from the one or more candidate machine learning models based on a set of anchor devices that are observable by the user device; and means for engaging in a positioning procedure that is based on the selected machine learning model with at least a subset of the corresponding set of anchor devices of the one or more candidate sets of anchor devices for determining an estimated location of the user device.

Clause 68. The user device of clause 67, wherein the assistance information is received from the network entity via broadcasting, multicasting, or unicasting.

Clause 69. The user device of any of clauses 67 to 68, wherein the assistance information indicates model identifiers of the one or more candidate machine learning models.

Clause 70. The user device of any of clauses 67 to 69, wherein the means for engaging in the positioning procedure comprises: means for obtaining measurements of signals between the user device and at least the subset of the corresponding set of anchor devices; and means for applying the selected machine learning model to the measurements to obtain the estimated location of the user device.

Clause 71. The user device of any of clauses 67 to 70, further comprising: means for receiving the selected machine learning model from the network entity or a server device different from the network entity.

Clause 72. The user device of any of clauses 67 to 69, wherein the means for engaging in the positioning procedure comprises: means for obtaining measurements of signals between the user device and at least the subset of the corresponding set of anchor devices; and means for transmitting the measurements to the network entity.

Clause 73. The user device of any of clauses 67 to 72, wherein the one or more candidate sets of anchor devices include: one or more transmission-reception points (TRPs), one or more user equipments (UEs), one or more roadside units (RSUs), one or more access points (APs), or any combination thereof.

Clause 74. A network entity, comprising: means for obtaining device information of a user device; and means for transmitting assistance information to the user device based on the device information, the assistance information indicating one or more candidate machine learning models corresponding to respective one or more candidate sets of anchor devices, wherein at least a machine learning model of the one or more candidate machine learning models is selectable for determination of an estimated location of the user device.

Clause 75. The network entity of clause 74, wherein the device information indicating a coarse location of the user device.

Clause 76. The network entity of any of clauses 74 to 75, wherein the assistance information is transmitted by the network entity via broadcasting, multicasting, or unicasting.

Clause 77. The network entity of any of clauses 74 to 76, wherein the assistance information indicates model identifiers of the one or more candidate machine learning models.

Clause 78. The network entity of any of clauses 74 to 77, further comprising: means for obtaining an indication from the user device, the indication indicating the machine learning model of the one of the one or more candidate machine learning models for determining the estimated location of the user device.

Clause 79. The network entity of clause 78, further comprising: means for transmitting the machine learning model of the one or more candidate machine learning models to the user device in response to the indication.

Clause 80. The network entity of any of clauses 78 to 79, further comprising: means for receiving, from the user device, measurements of signals between the user device and at least a subset of the corresponding set of anchor devices of the one or more candidate sets of anchor devices that corresponds to the machine learning model; and means for applying the machine learning model to the measurements to obtain the estimated location of the user device.

Clause 81. The network entity of any of clauses 74 to 80, wherein the one or more candidate sets of anchor devices include: one or more transmission-reception points (TRPs), one or more user equipments (UEs), one or more roadside units (RSUs), one or more access points (APs), or any combination thereof.

Clause 82. A non-transitory computer-readable medium storing computer-executable instructions that, when executed by a user device, cause the user device to: transmit observable anchor information to a network entity, the observable anchor information indicating a set of anchor devices observable by the user device; obtain assistance information from the network entity, the assistance information indicating a machine learning model corresponding to the set of anchor devices; and engage in a positioning procedure that is based on the machine learning model with at least a subset of the set of anchor devices for determining an estimated location of the user device.

Clause 83. The non-transitory computer-readable medium of clause 82, wherein the assistance information provides the machine learning model, a model identifier of the machine learning model, or both.

Clause 84. The non-transitory computer-readable medium of any of clauses 82 to 83, wherein the observable anchor information indicates a list of the set of anchor devices, a cell identifier corresponding to the set of anchor devices, or a group identifier corresponding to the set of anchor devices.

Clause 85. The non-transitory computer-readable medium of any of clauses 82 to 84, wherein the instructions that cause the user device to engage in the positioning procedure comprises instructions that, when executed by the user device, cause the user device to: obtain measurements of signals between the user device and at least the subset of the set of anchor devices; and apply the machine learning model to the measurements to obtain the estimated location of the user device.

Clause 86. The non-transitory computer-readable medium of any of clauses 82 to 85, further comprising computer-executable instructions that, when executed by the user device, cause the user device to: receive the machine learning model from the network entity or a server device different from the network entity.

Clause 87. The non-transitory computer-readable medium of any of clauses 82 to 84. wherein the instructions that cause the user device to engage in the positioning procedure comprises instructions that, when executed by the user device, cause the user device to: obtain measurements of signals between the user device and the subset of the set of anchor devices; and transmit the measurements to the network entity.

Clause 88. The non-transitory computer-readable medium of any of clauses 82 to 87, wherein the set of anchor devices includes: one or more transmission-reception points (TRPs), one or more user equipments (UEs), one or more roadside units (RSUs), one or more access points (APs), or any combination thereof.

Clause 89. A non-transitory computer-readable medium storing computer-executable instructions that, when executed by a network entity, cause the network entity to: receive observable anchor information from a user device, the observable anchor information indicating a set of anchor devices observable by the user device; and transmit assistance information to the user device based on a machine learning model corresponding to the set of anchor devices being available, wherein the machine learning model is usable for determining an estimated location of the user device.

Clause 90. The non-transitory computer-readable medium of clause 89, wherein the observable anchor information indicates a list of the set of anchor devices, a cell identifier corresponding to the set of anchor devices, or a group identifier corresponding to the set of anchor devices.

Clause 91. The non-transitory computer-readable medium of any of clauses 89 to 90, wherein the assistance information provides the machine learning model, a model identifier of the machine learning model, or both.

Clause 92. The non-transitory computer-readable medium of any of clauses 89 to 91, further comprising computer-executable instructions that, when executed by the network entity, cause the network entity to: receive, from the user device, measurements of signals between the user device and at least a subset of the set of anchor devices; and apply the machine learning model to the measurements to obtain the estimated location of the user device.

Clause 93. The non-transitory computer-readable medium of any of clauses 89 to 92, wherein the set of anchor devices includes; one or more transmission-reception points (TRPs), one or more user equipments (UEs), one or more roadside units (RSUs), one or more access points (APs), or any combination thereof.

Clause 94. A non-transitory computer-readable medium storing computer-executable instructions that, when executed by a user device, cause the user device to: obtain assistance information from a network entity, the assistance information indicating one or more candidate machine learning models corresponding to respective one or more candidate sets of anchor devices; select a machine learning model from the one or more candidate machine learning models based on a set of anchor devices that are observable by the user device; and engage in a positioning procedure that is based on the selected machine learning model with at least a subset of the corresponding set of anchor devices of the one or more candidate sets of anchor devices for determining an estimated location of the user device.

Clause 95. The non-transitory computer-readable medium of clause 94, wherein the assistance information is received from the network entity via broadcasting, multicasting, or unicasting.

Clause 96. The non-transitory computer-readable medium of any of clauses 94 to 95, wherein the assistance information indicates model identifiers of the one or more candidate machine learning models.

Clause 97. The non-transitory computer-readable medium of any of clauses 94 to 96, wherein the instructions that cause the user device to engage in the positioning procedure comprises instructions that, when executed by the user device, cause the user device to: obtain measurements of signals between the user device and at least the subset of the corresponding set of anchor devices; and apply the selected machine learning model to the measurements to obtain the estimated location of the user device,

Clause 98. The non-transitory computer-readable medium of any of clauses 94 to 97, further comprising computer-executable instructions that, when executed by the user device, cause the user device to: receive the selected machine learning model from the network entity or a server device different from the network entity.

Clause 99. The non-transitory computer-readable medium of any of clauses 94 to 96, wherein the instructions that cause the user device to engage in the positioning procedure comprises instructions that, when executed by the user device, cause the user device to: obtain measurements of signals between the user device and at least the subset of the corresponding set of anchor devices; and transmit the measurements to the network entity,

Clause 100. The non-transitory computer-readable medium of any of clauses 94 to 99, wherein the one or more candidate sets of anchor devices include: one or more transmission-reception points (TRPs), one or more user equipments (UEs), one or more roadside units (RSUs), one or more access points (APs), or any combination thereof.

Clause 101. A non-transitory computer-readable medium storing computer-executable instructions that, when executed by a network entity, cause the network entity to: obtain device information of a user device; and transmit assistance information to the user device based on the device information, the assistance information indicating one or more candidate machine learning models corresponding to respective one or more candidate sets of anchor devices, wherein at least a machine learning model of the one or more candidate machine learning models is selectable for determination of an estimated location of the user device.

Clause 102. The non-transitory computer-readable medium of clause 101, wherein the device information indicating a coarse location of the user device.

Clause 103. The non-transitory computer-readable medium of any of clauses 101 to 102, wherein the assistance information is transmitted by the network entity via broadcasting, multicasting, or unicasting.

Clause 104. The non-transitory computer-readable medium of any of clauses 101 to 103, wherein the assistance information indicates model identifiers of the one or more candidate machine learning models.

Clause 105. The non-transitory computer-readable medium of any of clauses 101 to 104. further comprising computer-executable instructions that, when executed by the network entity, cause the network entity to: obtain an indication from the user device, the indication indicating the machine learning model of the one of the one or more candidate machine learning models for determining the estimated location of the user device.

Clause 106. The non-transitory computer-readable medium of clause 105, further comprising computer-executable instructions that, when executed by the network entity, cause the network entity to: transmit the machine learning model of the one or more candidate machine learning models to the user device in response to the indication,

Clause 107. The non-transitory computer-readable medium of any of clauses 105 to 106, further comprising computer-executable instructions that, when executed by the network entity, cause the network entity to: receive, from the user device, measurements of signals between the user device and at least a subset of the corresponding set of anchor devices of the one or more candidate sets of anchor devices that corresponds to the machine learning model; and apply the machine learning model to the measurements to obtain the estimated location of the user device.

Clause 108. The non-transitory computer-readable medium of any of clauses 101 to 107, wherein the one or more candidate sets of anchor devices include: one or more transmission-reception points (TRPs), one or more user equipments (UEs), one or more roadside units (RSUs), one or more access points (APs), or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents. electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed berein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared. radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a user device, comprising:
transmitting observable anchor information to a network entity, the observable anchor information indicating a set of anchor devices observable by the user device;
obtaining assistance information from the network entity, the assistance information indicating a machine learning model corresponding to the set of anchor devices; and
engaging in a positioning procedure that is based on the machine learning model with at least a subset of the set of anchor devices for determining an estimated location of the user device.

2. The method of claim 1, wherein the assistance information provides the machine learning model, a model identifier of the machine learning model, or both.

3. The method of claim 1, wherein the observable anchor information indicates a list of the set of anchor devices, a cell identifier corresponding to the set of anchor devices, or a group identifier corresponding to the set of anchor devices.

4. The method of claim 1, wherein the engaging in the positioning procedure comprises:
obtaining measurements of signals between the user device and at least the subset of the set of anchor devices; and
applying the machine learning model to the measurements to obtain the estimated location of the user device.

5. The method of claim 1, further comprising:
receiving the machine learning model from the network entity or a server device different from the network entity.

6. The method of claim 1, wherein the engaging in the positioning procedure comprises:
obtaining measurements of signals between the user device and the subset of the set of anchor devices; and
transmitting the measurements to the network entity.

7. The method of claim 1, wherein the set of anchor devices includes:
one or more transmission-reception points (TRPs),
one or more user equipments (UEs),
one or more roadside units (RSUs),
one or more access points (APs), or
any combination thereof.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A user device, comprising:
a memory;
at least one transceiver; and
at least one processor communicatively coupled to the memory and the at least one transceiver, the at least one processor configured to:
transmit, via the at least one transceiver, observable anchor information to a network entity, the observable anchor information indicating a set of anchor devices observable by the user device;
obtain assistance information from the network entity, the assistance information indicating a machine learning model corresponding to the set of anchor devices; and
engage in a positioning procedure that is based on the machine learning model with at least a subset of the set of anchor devices for determining an estimated location of the user device.

29. The user device of claim 28, wherein the at least one processor configured to engage in the positioning procedure is further configured to:
obtain measurements of signals between the user device and at least the subset of the set of anchor devices; and
apply the machine learning model to the measurements to obtain the estimated location of the user device.

30. The user device of claim 28, wherein the at least one processor configured to engage in the positioning procedure is further configured to:
obtain measurements of signals between the user device and the subset of the set of anchor devices; and
transmit, via the at least one transceiver, the measurements to the network entity.

31. (canceled)

32. (canceled)

33. A user device, comprising:
a memory;
at least one transceiver; and
at least one processor communicatively coupled to the memory and the at least one transceiver, the at least one processor configured to:
obtain assistance information from a network entity, the assistance information indicating one or more candidate machine learning models corresponding to respective one or more candidate sets of anchor devices;
select a machine learning model from the one or more candidate machine learning models based on a set of anchor devices that are observable by the user device; and
engage in a positioning procedure that is based on the selected machine learning model with at least a subset of the corresponding set of anchor devices of the one or more candidate sets of anchor devices for determining an estimated location of the user device.

34. The user device of claim 33, wherein the assistance information is received from the network entity via broadcasting, multicasting, or unicasting.

35. The user device of claim 33, wherein the at least one processor configured to engage in the positioning procedure is further configured to:
obtain measurements of signals between the user device and at least the subset of the corresponding set of anchor devices; and
apply the selected machine learning model to the measurements to obtain the estimated location of the user device.

36. The user device of claim 33, wherein the at least one processor configured to engage in the positioning procedure is further configured to:
obtain measurements of signals between the user device and at least the subset of the corresponding set of anchor devices; and
transmit, via the at least one transceiver, the measurements to the network entity.

37. (canceled)

38. (canceled)

39. (canceled)

40. (canceled)
